(19) United States
(12) Patent Application Publication
(10) Pub. No.: US 2005/0017999 A1
(43) Pub. Date: Jan. 27, 2005

(54) Printing method, printing apparatus, computer-readable storage medium, and correction pattern

(75) Inventor: Masahiko Yoshida, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/849,555

(22) Filed: May 20, 2004

(30) Foreign Application Priority Data
May 20, 2003 (JP) 2003-142036
May 20, 2003 (JP) 2003-142037

(51) Int. Cl. B41J 29/38

(52) U.S. Cl. 347/6

(57) ABSTRACT

A printing method includes the steps of: printing a print correction pattern on a medium, wherein the print correction pattern is made up of a plurality of patterns, wherein each of the plurality of patterns has a dot recording ratio different from one another, wherein the dot recording ratio is a ratio at which dots are recorded per unit area, wherein each of the plurality of patterns is formed from a multitude of dots, and wherein each of the dots is formed by an ink droplet being ejected onto the medium; and adjusting a relationship between a gray-scale value of the dots and the dot recording ratio according to a result of detecting a dispersion state of the multitude of dots in each of the plurality of patterns included in the print correction pattern that has been printed.

### CROSS-REFERENCE TO RELATED APPLICATIONS

The present application claims priority upon Japanese Patent Application No. 2003-142036 filed on May 20, 2003 and Japanese Patent Application No. 2003-142037 filed on May 20, 2003, which are herein incorporated by reference.

### BACKGROUND OF THE INVENTION

1. Field of the Invention

The present invention relates to printing methods, printing apparatuses, computer-readable storage media, and correction patterns.

2. Description of the Related Art

In recent years, printers that form dots on a print medium by ejecting several colors of ink from a plurality of nozzles provided on a print head, and that print images processed by a computer, have become widely used as one type of output apparatus for computers.

However, in such printers, a shift sometimes occurs in the landing positions of ink droplets that are ejected from the nozzles, due to factors such as the machining accuracy of the nozzles. In such cases, for example, when the shift in the ink droplets occurs in a sub-scanning direction (a direction that is perpendicular to a scanning direction of the print head (the main-scanning direction)), darkness non-uniformities such as white streaks may occur across the printed image, since a portion of the dots that would be arranged in a well ordered matrix shape if the situation was normal are shifted in the sub-scanning direction.

Conventionally, print correction patterns that are printed by printers are converted to electrical signals by CCDs (Charge Couple Devices) and input, and darkness non-uniformities detected by weighting of error diffusion methods are corrected. (For example, see JP 02-54676A).

(1) Printers that have a plurality of different dot sizes, and that are capable of expressing an increased number of gray-scale values by appropriate selection of the plurality of sizes of dots, have come into general use in recent years.

In such printers, the output characteristic, that is, the flying trajectory of the ink droplets that are ejected differs according to the dot size, and therefore, correction of the darkness non-uniformities has been problematic.

(2) Furthermore, rendering methods such as the interlace method, in which an image that is to be printed is rendered by dividing it over a plurality of scans, have been proposed in recent years. FIG. 21 is a diagram that shows an example of the interlace printing method.

In this diagram, round marks indicate dots that are formed on the print medium, and numbers inside the round marks indicate the number of the nozzle that formed the dot. First, the dots of number 1 to number 5 shown by white circles are formed by a first scan. Then, after feeding the paper forward by a predetermined amount L, the vertically hatched round dots are printed in a second scan. Similarly, after feeding the paper forward by the predetermined amount L, the obliquely hatched round dots are printed in a third scan.

On the other hand, as shown in FIG. 22, if the paper feed amount is smaller by an amount d (error) than the predetermined amount L (i.e., if there is a shift), then the dots will be printed shifted in the upward direction of the diagram. As a result, a white space is created in the rows in the vertical direction of the dots; that is, there are cases in which white streaks occur.

In such cases, even if an attempt is made to correct the darkness non-uniformities by the method described above, since darkness non-uniformities caused by the error in the paper feed amount are mixed with the darkness non-uniformities caused by the error of the nozzles, it is very difficult to eliminate the darkness non-uniformities.

Moreover, there are printers using interlace method that are capable of forming dots of a plurality of different sizes. In such printers, darkness non-uniformities are not only caused by both the error of the paper feed amount and the error of the nozzles, but darkness non-uniformities can be caused by differences in dot sizes, and thus, correction of the darkness non-uniformities is made even more difficult.

### SUMMARY OF THE INVENTION

The present invention has been made in view of the above issues.

(1) It is a first object of the present invention to provide a printing method, a printing apparatus, a computer-readable storage medium, and a correction pattern which allow easy adjustment of non-uniformities in printing.

(2) It is another object of the present invention to provide a printing method, a printing apparatus, a computer-readable storage medium, and a correction pattern which allow easy adjustment of non-uniformities in printing, even if an image that is to be printed is rendered by dividing it over a plurality of scans.

(1) According to a first aspect of the present invention, a printing method comprises the steps of:
printing a print correction pattern on a medium, wherein the print correction pattern is made up of a plurality of patterns, wherein each of the plurality of patterns has a dot recording ratio different from one another, wherein the dot recording ratio is a ratio at which dots are recorded per unit area, wherein each of the plurality of patterns is formed from a multitude of dots, and wherein each of the dots is formed by an ink droplet being ejected onto the medium; and
adjusting a relationship between a gray-scale value of the dots and the dot recording ratio according to a result of detecting a dispersion state of the multitude of dots in each of the plurality of patterns included in the print correction pattern that has been printed.

(2) According to another aspect of the present invention, a printing method of intermittently feeding a medium by a predetermined feed amount and printing on the medium during intervals between the intermittent feeding, comprises the steps of:
printing, on the medium, a feed amount correction pattern for correcting the feed amount of the medium;
correcting the feed amount of the medium based on the feed amount correction pattern;
printing a print correction pattern on the medium, wherein the print correction pattern is made up of a plurality of patterns, wherein each of the plurality of patterns has a dot recording ratio different from one another, wherein the dot recording ratio is a ratio at which dots are recorded per unit area, wherein each of the plurality of patterns is formed from a multitude of dots, and wherein each of the dots is formed by an ink droplet being ejected onto the medium; and
adjusting a relationship between a gray-scale value of the dots and the dot recording ratio according to a result of detecting a dispersion state of the multitude of dots in each of the plurality of patterns included in the print correction pattern that has been printed.

Other features of the present invention will become clear through the accompanying drawings and the following description.

### BRIEF DESCRIPTION OF THE DRAWINGS

For a more complete understanding of the present invention and the advantages thereof, reference is now made to the following description taken in conjunction with the accompanying drawings wherein:

FIG. 1 is a diagram schematically showing a configuration of main components of a printing apparatus according to an embodiment;

FIG. 2 is a block diagram showing a configuration of main components of a printer, centering on a control circuit, in the printing apparatus shown in FIG. 1;

FIG. 3 is a block diagram showing a detailed configuration of a computer in the printing apparatus shown in FIG. 1;

FIG. 4 is a diagram for illustrating details on various programs that are installed in the computer in the printing apparatus shown in FIG. 1;

FIG. 5 is a flow chart for illustrating a detailed flow of a process executed by a printer driver program that is installed in the computer in the printing apparatus shown in FIG. 1;

FIG. 6 is a flow chart for illustrating a detailed flow of a halftone process shown in the flow chart of FIG. 5;

FIG. 7 is a diagram showing contents of a recording ratio table shown in FIG. 4 and illustrates details of a recording ratio table that is used in determining level data for large, middle-size and small dots;

FIG. 8 is a diagram showing the manner in which dots are judged to be on or off according to the dither method that is executed in the halftone module shown in FIG. 4;

FIG. 9 is a diagram illustrating the relationship between a dither matrix used for determining large dots, and a dither matrix used for determining middle-size dots, wherein the dither matrices are used in dithering that is executed in the halftone module shown in FIG. 4;

FIG. 10A and FIG. 10B are diagrams showing the contents of the recording ratio table shown in FIG. 4, and an ink ejection amount that corresponds to those contents, wherein FIG. 10A is a diagram showing a recording ratio table in which a gray-scale value and a dot recording ratio are related, and FIG. 10B is a diagram showing a relationship between the gray-scale values and the ink ejection amount;

FIG. 11A and FIG. 11B are diagrams showing a relationship between a dot recording ratio and banding in the printing apparatus shown in FIG. 1, wherein FIG. 11A shows the manner in which small dots are printed at a dot recording ratio of 33% in an 8×6 matrix, and FIG. 11B shows the manner in which small dots are printed at a dot recording ratio of 44% in an 8×6 matrix;

FIG. 12A and FIG. 12B are diagrams that show a relationship between a dot recording ratio and banding in the printing apparatus that is shown in FIG. 1, wherein FIG. 12A shows the manner in which small dots are printed at a dot recording ratio of 100% in an 8×6 matrix, and FIG. 12B shows the manner in which one portion of the small dots in FIG. 11B are exchanged for middle-size dots;

FIG. 13 is a flow chart illustrating the flow of a process for setting the recording ratio table that is for determining timing of a change-over in dot size in the printing apparatus shown in FIG. 1;

FIG. 14 is an example of the recording ratio table shown in FIG. 4, and is a diagram showing a relationship between a dot recording ratio of small dots and of middle-size dots;

FIG. 15 is a diagram showing an example of a correction pattern that is printed in the printing apparatus shown in FIG. 1;

FIG. 16 is a diagram showing a result of reading a single print correction pattern shown in FIG. 15 with an optical sensor shown in FIG. 1, and is a diagram that shows a relationship between a nozzle position and output of the optical sensor;

FIG. 17 is a diagram showing an example of a new recording ratio table obtained from the recording ratio table shown in FIG. 14 being corrected according to the process shown in FIG. 13;

FIG. 18 is a diagram illustrating the flow of a process that is executed when correcting a paper feed amount of the printing apparatus shown in FIG. 1;

FIG. 19 is a diagram showing an example of a print correction pattern for correcting a feed amount of paper that is printed according to the process that is shown in FIG. 18;

FIG. 20 is a flow chart illustrating the flow of a process for setting a recording rate table for determining the timing of a change-over in dot size in the printing apparatus shown in FIG. 1;

FIG. 21 is a diagram showing an example of an interlace printing method; and

FIG. 22 is a diagram showing the manner in which a paper feed amount is less than a predetermined amount L by an amount d, in interlace printing.

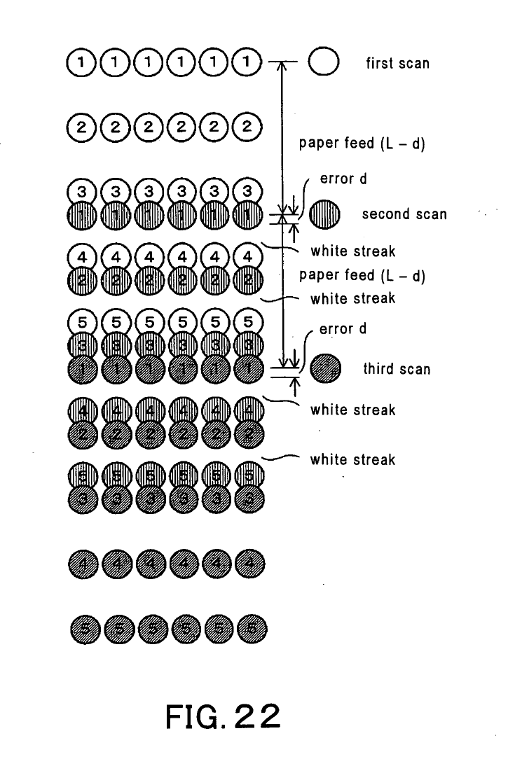

### DETAILED DESCRIPTION OF PREFERRED EMBODIMENTS

At least the following matters will be made clear by the description in the present specification and the accompanying drawings.

(1) A first aspect of the present invention is a printing method comprising the steps of:
printing a print correction pattern on a medium, wherein the print correction pattern is made up of a plurality of patterns, wherein each of the plurality of patterns has a dot recording ratio different from one another, wherein the dot recording ratio is a ratio at which dots are recorded per unit area, wherein each of the plurality of patterns is formed from a multitude of dots, and wherein each of the dots is formed by an ink droplet being ejected onto the medium; and
adjusting a relationship between a gray-scale value of the dots and the dot recording ratio according to a result of detecting a dispersion state of the multitude of dots in each of the plurality of patterns included in the print correction pattern that has been printed.

According to this method, non-uniformities in printing can be easily adjusted.

Further, in the printing step, N types of the print correction patterns, each being formed from dots of a size that differs from the other types, may be printed by ejecting, onto the medium, N types of ink droplets that respectively have different ink amounts; N may be an integer of at least 2; and the relationship between the gray-scale value and the dot recording ratio may be adjusted for each of the N types of dots of different sizes formed by ejecting the N types of ink droplets.

According to this method, it is possible to easily adjust non-uniformities in printing, even in the case where there are a plurality of dot sizes.

Further, in the printing step, the print correction pattern that is formed from dots of the smallest size, and one or two or more of the print correction patterns that are formed from dots of the next smallest one or two or more different sizes, may be printed by ejecting, onto the medium, ink droplets whose ink amount is the smallest among the N types of ink droplets, and one or two or more types of ink droplets whose ink amount is next smallest.

According to this method, it is possible to optimally adjust the settings for ink droplets with a small amount of ink, which are most likely to cause banding.

Further, if, by detecting the dispersion state of the multitude of dots, the occurrence of banding is detected in one of the plurality of patterns that are included in the print correction pattern that is formed from dots of a particular size, then an upper limit of the dot recording ratio for the dots of the particular size may be set to a value in the vicinity of the dot recording ratio of the one pattern in which the banding is occurring, and the dot recording ratio for dots of a size that is larger than the dots of the particular size may be changed.

According to this method, it is possible to reliably suppress the occurrence of banding.

Further, the ink droplets may be ejected from a plurality of nozzles; and for only the nozzle, from among the plurality of nozzles, that caused the banding, the dot recording ratio may be changed such that dots other than the dots of the smallest size, which are formed by the ink droplets that are ejected from the nozzle, are created starting from a smaller gray-scale value.

According to this method, it is possible to effectively suppress banding, without changing the image quality of the parts of the image in which banding does not occur.

Further, the ink droplets may be ejected from a plurality of nozzles; and for the nozzle, from among the plurality of nozzles, that caused the banding and at least one other nozzle in the vicinity of the nozzle, the dot recording ratio for dots other than the dots of the smallest size, which are formed by the ink droplets that are ejected from those nozzles, may be made larger.

According to this method, banding can be suppressed more reliably than when only a single nozzle is adjusted.

Further, the ink droplets are ejected from a plurality of nozzles; and for all of the plurality of nozzles, the dot recording ratio for dots formed by the ink droplets that are ejected from each of the nozzles is adjusted.

According to this method, it is possible to suppress the occurrence of non-uniformities in image quality that are caused by discrepancies between dot recording ratios of parts that have been adjusted and other parts.

Further, the plurality of patterns that are included in the print correction pattern may be read optically; and whether or not banding has occurred in any of the plurality of patterns may be detected based on results of the reading.

According to this method, it is possible to easily detect the occurrence of banding.

It is also possible to achieve a printing method comprising the steps of:
printing a print correction pattern on a medium, wherein the print correction pattern is made up of a plurality of patterns, wherein each of the plurality of patterns has a dot recording ratio different from one another, wherein the dot recording ratio is a ratio at which dots are recorded per unit area, wherein each of the plurality of patterns is formed from a multitude of dots, and wherein each of the dots is formed by an ink droplet being ejected onto the medium; and
adjusting a relationship between a gray-scale value of the dots and the dot recording ratio according to a result of optically reading and detecting a dispersion state of the multitude of dots in each of the plurality of patterns included in the print correction pattern that has been printed;
wherein, in the printing step, N types of the print correction patterns, each being formed from dots of a size that differs from the other types, are printed by ejecting, onto the medium, N types of ink droplets that respectively have different ink amounts;
wherein N is an integer of at least 2;
wherein the relationship between the gray-scale value and the dot recording ratio is adjusted for each of the N types of dots of different sizes formed by ejecting the N types of ink droplets;
wherein, in the printing step, the print correction pattern that is formed from dots of the smallest size, and one or two or more of the print correction patterns that are formed from dots of the next smallest one or two or more different sizes, are printed by ejecting, onto the medium, ink droplets whose ink amount is the smallest among the N types of ink droplets, and one or two or more types of ink droplets whose ink amount is next smallest;
wherein, if, by detecting the dispersion state of the multitude of dots, the occurrence of banding is detected in one of the plurality of patterns that are included in the print correction pattern that is formed from dots of a particular size, then
an upper limit of the dot recording ratio for the dots of the particular size is set to a value in the vicinity of the dot recording ratio of the one pattern in which the banding is occurring, and
the dot recording ratio for dots of a size that is larger than the dots of the particular size is changed;
wherein the ink droplets are ejected from a plurality of nozzles;
wherein, for only the nozzle, from among the plurality of nozzles, that caused the banding, the dot recording ratio is changed such that dots other than the dots of the smallest size, which are formed by the ink droplets that are ejected from the nozzle, are created starting from a smaller gray-scale value; and
wherein, for the nozzle, from among the plurality of nozzles, that caused the banding and at least one other nozzle in the vicinity of the nozzle, the dot recording ratio for dots other than the dots of the smallest size, which are formed by the ink droplets that are ejected from those nozzles, is made larger.

Further, it is also possible to achieve a printing apparatus comprising:
a plurality of nozzles for ejecting ink droplets onto a medium to form dots on the medium; and
a controller for controlling actions of the plurality of nozzles; the controller causing the plurality of nozzles to print a print correction pattern on the medium, wherein the print correction pattern is made up of a plurality of patterns, wherein each of the plurality of patterns has a dot recording ratio different from one another, wherein the dot recording ratio is a ratio at which dots are recorded per unit area, wherein each of the plurality of patterns is formed from a multitude of dots, and wherein each of the dots is formed by one of the plurality of nozzles ejecting an ink droplet onto the medium; and the controller adjusting a relationship between a gray-scale value of the dots and the dot recording ratio according to a result of detecting a dispersion state of the multitude of dots in each of the plurality of patterns included in the print correction pattern that has been printed.

Further, it is also possible to achieve a computer-readable storage medium having recorded thereon a program, wherein the program is for a printing apparatus, and the program causes the printing apparatus to execute:
a step of printing a print correction pattern on a medium, wherein the print correction pattern is made up of a plurality of patterns, wherein each of the plurality of patterns has a dot recording ratio different from one another, wherein the dot recording ratio is a ratio at which dots are recorded per unit area, wherein each of the plurality of patterns is formed from a multitude of dots, and wherein each of the dots is formed by an ink droplet being ejected onto the medium; and
a step of adjusting a relationship between a gray-scale value of the dots and the dot recording ratio according to a result of detecting a dispersion state of the multitude of dots in each of the plurality of patterns included in the print correction pattern that has been printed.

Further, it is also possible to achieve a print correction pattern that is printed on a medium, comprising:
a plurality of patterns, each of the plurality of patterns having a dot recording ratio different from one another;
wherein the dot recording ratio is a ratio at which dots are recorded per unit area;
wherein each of the plurality of patterns is formed from a multitude of dots;
wherein each of the dots is formed by an ink droplet being ejected onto the medium; and
wherein the print correction pattern is used for adjusting a relationship between a gray-scale value of the dots and the dot recording ratio according to a result of detecting a dispersion state of the multitude of dots in each of the plurality of patterns included in the print correction pattern that has been printed.

(2) Another aspect of the present invention is a printing method of intermittently feeding a medium by a predetermined feed amount and printing on the medium during intervals between the intermittent feeding, comprising the steps of:
printing, on the medium, a feed amount correction pattern for correcting the feed amount of the medium;
correcting the feed amount of the medium based on the feed amount correction pattern;
printing a print correction pattern on the medium, wherein the print correction pattern is made up of a plurality of patterns, wherein each of the plurality of patterns has a dot recording ratio different from one another, wherein the dot recording ratio is a ratio at which dots are recorded per unit area, wherein each of the plurality of patterns is formed from a multitude of dots, and wherein each of the dots is formed by an ink droplet being ejected onto the medium; and
adjusting a relationship between a gray-scale value of the dots and the dot recording ratio according to a result of detecting a dispersion state of the multitude of dots in each of the plurality of patterns included in the print correction pattern that has been printed.

According to this method, it is possible to easily adjust non-uniformities in printing, even if an image that is to be printed is rendered by dividing the image among a plurality of scans.

Further, in the step of printing the print correction pattern, N types of the print correction patterns, each being formed from dots of a size that differs from the other types, may be printed by ejecting, onto the medium, N types of ink droplets that respectively have different ink amounts; N may be an integer of at least 2; and the relationship between the gray-scale value and the dot recording ratio may be adjusted for each of the N types of dots of different sizes formed by ejecting the N types of ink droplets.

According to this method, it is possible to easily adjust non-uniformities in printing, even when a single pixel is constituted by N types of ink droplets.

Further, the ink droplets may be ejected from a plurality of nozzles; during the intervals between the intermittent feeding, a line may be formed on the medium in a direction that intersects a feed direction of the medium by repeatedly ejecting the ink droplets from at least one of the plurality of nozzles; the feed amount correction pattern may include at least two of the lines; and in the step of correcting the feed amount, the feed amount of the medium may be corrected according to the lines that are included in the feed amount correction pattern.

According to this method, it is possible to accurately determine the feed amount of the print medium according to these lines.

Further, in the step of correcting the feed amount, the lines that are included in the feed amount correction pattern may be optically read, and the feed amount of the medium may be corrected according to a result of the reading.

According to this method, it is possible to easily and accurately determine the feed amount of the print medium according to these lines.

Further, in the step of adjusting, the plurality of patterns that are included in the print correction pattern may be optically read, and the relationship between the gray-scale value of the dots and the dot recording ratio may be adjusted according to a result of the reading.

According to this method, it is possible to easily and accurately determine not only the feed amount, but also the dot recording ratio.

Another aspect of the present invention is a printing method of intermittently feeding a medium by a predetermined feed amount and printing on the medium during intervals between the intermittent feeding, comprising the steps of:
printing, on the medium, a feed amount correction pattern for correcting the feed amount of the medium;
correcting the feed amount of the medium based on the feed amount correction pattern;
printing a print correction pattern on the medium, wherein the print correction pattern is made up of a plurality of patterns, wherein each of the plurality of patterns has a dot recording ratio different from one another, wherein the dot recording ratio is a ratio at which dots are recorded per unit area, wherein each of the plurality of patterns is formed from a multitude of dots, and wherein each of the dots is formed by an ink droplet being ejected onto the medium;
adjusting a relationship between a gray-scale value of the dots and the dot recording ratio according to a result of detecting a dispersion state of the multitude of dots in each of the plurality of patterns included in the print correction pattern that has been printed;
printing the print correction pattern again according to the relationship between the gray-scale value of the dots and the dot recording ratio that has been adjusted in the step of adjusting; and
repeating the step of adjusting if the occurrence of banding is detected as a result of detecting whether or not banding has occurred in any of the plurality of patterns that are included in the print correction pattern that has been printed again.

According to this method, it is possible to easily adjust non-uniformities in printing, even if an image that is to be printed is rendered by dividing the image among a plurality of scans.

Further, if the occurrence of banding is detected even after the step of repeating, then the step of correcting the feed amount of the medium may be repeated.

According to this method, it is possible to accurately correct the feed amount, which is the cause of the occurrence of banding.

Further, if the occurrence of banding is caused by the presence of a portion of low darkness, then the feed amount may be corrected by reducing the feed amount.

According to this method, it is possible to accurately correct the feed amount, which is the cause of the occurrence of banding due to the presence of sections of low darkness.

Further, it is also possible to achieve a printing method of intermittently feeding a medium by a predetermined feed amount and printing on the medium during intervals between the intermittent feeding, comprising the steps of:
printing, on the medium, a feed amount correction pattern for correcting the feed amount of the medium;
correcting the feed amount of the medium based on the feed amount correction pattern;
printing a print correction pattern on the medium, wherein the print correction pattern is made up of a plurality of patterns, wherein each of the plurality of patterns has a dot recording ratio different from one another, wherein the dot recording ratio is a ratio at which dots are recorded per unit area, wherein each of the plurality of patterns is formed from a multitude of dots, and wherein each of the dots is formed by an ink droplet being ejected onto the medium; and
adjusting a relationship between a gray-scale value of the dots and the dot recording ratio according to a result of detecting a dispersion state of the multitude of dots in each of the plurality of patterns included in the print correction pattern that has been printed;
wherein, in the step of printing the print correction pattern, N types of the print correction patterns, each being formed from dots of a size that differs from the other types, are printed by ejecting, onto the medium, N types of ink droplets that respectively have different ink amounts;
wherein N is an integer of at least 2;
wherein the relationship between the gray-scale value and the dot recording ratio is adjusted for each of the N types of dots of different sizes formed by ejecting the N types of ink droplets;
wherein the ink droplets are ejected from a plurality of nozzles;
wherein, during the intervals between the intermittent feeding, a line is formed on the medium in a direction that intersects a feed direction of the medium by repeatedly ejecting the ink droplets from at least one of the plurality of nozzles;
wherein the feed amount correction pattern includes at least two of the lines;
wherein in the step of correcting the feed amount, the feed amount of the medium is corrected according to the lines that are included in the feed amount correction pattern;
wherein in the step of correcting the feed amount,
   the lines that are included in the feed amount correction pattern are optically read, and
   the feed amount of the medium is corrected according to a result of the reading; and
wherein in the step of adjusting,
   the plurality of patterns that are included in the print correction pattern are optically read, and
   the relationship between the gray-scale value of the dots and the dot recording ratio is adjusted according to a result of the reading.

Further, it is also possible to achieve a printing method of intermittently feeding a medium by a predetermined feed amount and printing on the medium during intervals between the intermittent feeding, comprising the steps of:
printing, on the medium, a feed amount correction pattern for correcting the feed amount of the medium;
correcting the feed amount of the medium based on the feed amount correction pattern;
printing a print correction pattern on the medium, wherein the print correction pattern is made up of a plurality of patterns, wherein each of the plurality of patterns has a dot recording ratio different from one another, wherein the dot recording ratio is a ratio at which dots are recorded per unit area, wherein each of the plurality of patterns is formed from a multitude of dots, and wherein each of the dots is formed by an ink droplet being ejected onto the medium;
adjusting a relationship between a gray-scale value of the dots and the dot recording ratio according to a result of detecting a dispersion state of the multitude of dots in each of the plurality of patterns included in the print correction pattern that has been printed;
printing the print correction pattern again according to the relationship between the gray-scale value of the dots and the dot recording ratio that has been adjusted in the step of adjusting; and
repeating the step of adjusting if the occurrence of banding is detected as a result of detecting whether or not banding has occurred in any of the plurality of patterns that are included in the print correction pattern that has been printed again;
wherein if the occurrence of banding is detected even after the step of repeating, then the step of correcting the feed amount of the medium is repeated; and
wherein if the occurrence of banding is caused by the presence of a portion of low darkness, then the feed amount is corrected by reducing the feed amount.

Further, it is also possible to achieve a printing apparatus comprising:
a carrying mechanism for intermittently feeding a medium by a predetermined feed amount;
a plurality of nozzles for ejecting ink droplets onto the medium to form dots on the medium during intervals between the intermittent feeding; and
a controller for controlling actions of the plurality of nozzles; the controller causing the plurality of nozzles to print, on the medium, a feed amount correction pattern for correcting the feed amount of the medium; the controller correcting the feed amount of the medium based on the feed amount correction pattern; the controller causing the plurality of nozzles to print a print correction pattern on the medium, wherein the print correction pattern is made up of a plurality of patterns, wherein each of the plurality of patterns has a dot recording ratio different from one another, wherein the dot recording ratio is a ratio at which dots are recorded per unit area, wherein each of the plurality of patterns is formed from a multitude of dots, and wherein each of the dots is formed by one of the plurality of nozzles ejecting an ink droplet onto the medium; and the controller adjusting a relationship between a gray-scale value of the dots and the dot recording ratio according to a result of detecting a dispersion state of the multitude of dots in each of the plurality of patterns included in the print correction pattern that has been printed.

Further, it is also possible to achieve a printing apparatus comprising:
a carrying mechanism for intermittently feeding a medium by a predetermined feed amount;
a plurality of nozzles for ejecting ink droplets onto the medium to form dots on the medium during intervals between the intermittent feeding; and
a controller for controlling actions of the plurality of nozzles; the controller causing the plurality of nozzles to print, on the medium, a feed amount correction pattern for correcting the feed amount of the medium; the controller correcting the feed amount of the medium based on the feed amount correction pattern; the controller causing the plurality of nozzles to print a print correction pattern on the medium, wherein the print correction pattern is made up of a plurality of patterns, wherein each of the plurality of patterns has a dot recording ratio different from one another, wherein the dot recording ratio is a ratio at which dots are recorded per unit area, wherein each of the plurality of patterns is formed from a multitude of dots, and wherein each of the dots is formed by one of the plurality of nozzles ejecting an ink droplet onto the medium; the controller adjusting a relationship between a gray-scale value of the dots and the dot recording ratio according to a result of detecting a dispersion state of the multitude of dots in each of the plurality of patterns included in the print correction pattern that has been printed; the controller causing the plurality of nozzles to print the print correction pattern again according to the relationship between the gray-scale value of the dots and the dot recording ratio that has been adjusted in the step of adjusting; and the controller repeating adjustment of the relationship between the gray-scale value of the dots and the dot recording ratio if the occurrence of banding is detected as a result of detecting whether or not banding has occurred in any of the plurality of patterns that are included in the print correction pattern that has been printed again.

Further, it is also possible to achieve a computer-readable storage medium having recorded thereon a program, wherein the program is for a printing apparatus that intermittently feeds a medium by a predetermined feed amount and prints on the medium during intervals between the intermittent feeding, and the program causes the printing apparatus to execute:
a step of printing, on the medium, a feed amount correction pattern for correcting the feed amount of the medium;
a step of correcting the feed amount of the medium based on the feed amount correction pattern;
a step of printing a print correction pattern on the medium, wherein the print correction pattern is made up of a plurality of patterns, wherein each of the plurality of patterns has a dot recording ratio different from one another, wherein the dot recording ratio is a ratio at which dots are recorded per unit area, wherein each of the plurality of patterns is formed from a multitude of dots, and wherein each of the dots is formed by an ink droplet being ejected onto the medium; and
a step of adjusting a relationship between a gray-scale value of the dots and the dot recording ratio according to a result of detecting a dispersion state of the multitude of dots in each of the plurality of patterns included in the print correction pattern that has been printed.

Further, it is also possible to achieve a computer-readable storage medium having recorded thereon a program, wherein the program is for a printing apparatus that intermittently feeds a medium by a predetermined feed amount and prints on the medium during intervals between the intermittent feeding, and the program causes the printing apparatus to execute:
a step of printing, on the medium, a feed amount correction pattern for correcting the feed amount of the medium;
a step of correcting the feed amount of the medium based on the feed amount correction pattern;
a step of printing a print correction pattern on the medium, wherein the print correction pattern is made up of a plurality of patterns, wherein each of the plurality of patterns has a dot recording ratio different from one another, wherein the dot recording ratio is a ratio at which dots are recorded per unit area, wherein each of the plurality of patterns is formed from a multitude of dots, and wherein each of the dots is formed by an ink droplet being ejected onto the medium;
a step of adjusting a relationship between a gray-scale value of the dots and the dot recording ratio according to a result of detecting a dispersion state of the multitude of dots in each of the plurality of patterns included in the print correction pattern that has been printed;
a step of printing the print correction pattern again according to the relationship between the gray-scale value of the dots and the dot recording ratio that has been adjusted in the step of adjusting; and
a step of repeating the step of adjusting if the occurrence of banding is detected as a result of detecting whether or not banding has occurred in any of the plurality of patterns that are included in the print correction pattern that has been printed again.

Further, it is also possible to achieve a print correction pattern that is printed on a medium, comprising:
a feed amount correction pattern for correcting the feed amount of the medium; and
a plurality of patterns, each of the plurality of patterns having a dot recording ratio different from one another;
wherein the feed amount correction pattern is used for correcting the feed amount of the medium;
wherein the dot recording ratio is a ratio at which dots are recorded per unit area;
wherein each of the plurality of patterns is formed from a multitude of dots;
wherein each of the dots is formed by an ink droplet being ejected onto the medium; and
wherein the print correction pattern is used for adjusting a relationship between a gray-scale value of the dots and the dot recording ratio according to a result of detecting a dispersion state of the multitude of dots in each of the plurality of patterns included in the print correction pattern that has been printed.
   ===Overall Configuration Example of Printing Apparatus===

An embodiment of the present invention is described below with reference to the drawings.

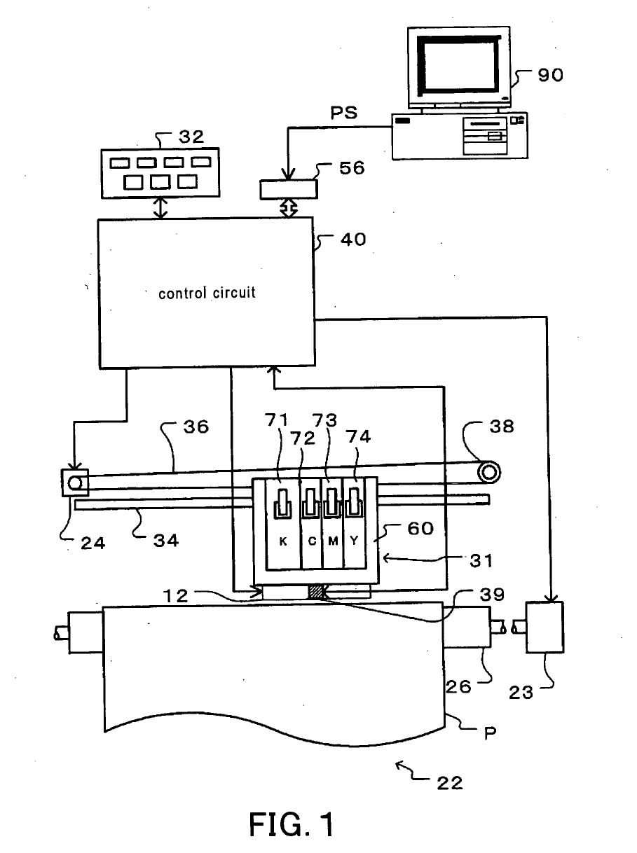

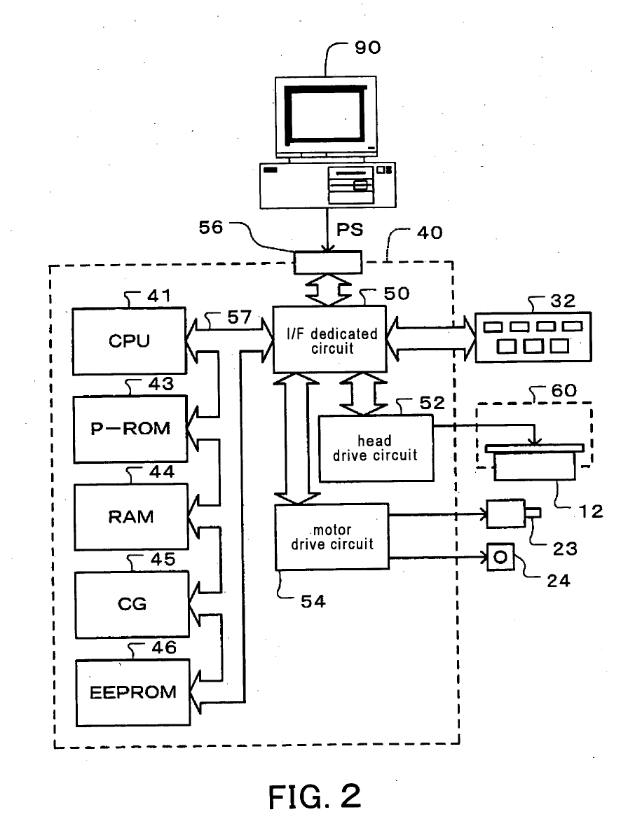

First, an overview of a printing apparatus is described with reference to FIG. 1 and FIG. 2. It should be noted that the combination of a printer 22 and a computer 90 is referred to as the “printing apparatus” below.

FIG. 1 is a schematic configuration diagram of the printer 22 that constructs the printing apparatus. FIG. 2 is a block diagram showing a configuration example of main components of the printer 22, centering on a control circuit 40.

As shown in FIG. 1, the printer 22 includes a sub-scan carrying mechanism for carrying print paper P with a paper feed motor 23, and a main-scan carrying mechanism for moving a carriage 31 back and forth in the axial direction of a paper feed roller 26 with a carriage motor 24. The direction in which the print paper P is fed by the sub-scan carrying mechanism is herein referred to as the “sub-scanning direction”, and the direction in which the carriage 31 is moved by the main-scan carrying mechanism is referred to as the “main-scanning direction”.

The printer 22 also includes: a print head unit 60 that is mounted on the carriage 31 and that has a print head 12; a head drive mechanism for driving the print head unit 60 to control ink ejection and dot formation; and a control circuit 40 that manages signal exchange among the paper feed motor 23, the carriage motor 24, the print head unit 60, and a control panel 32.

Next, the configuration of the print head 12, which is an example of a feed amount correction pattern printing means and of a print correction pattern printing means, is described with reference to FIG. 1.

As shown in FIG. 1, on the carriage 31, four ink cartridges 71 through 74, that is, a cartridge 71 containing black (K) ink, a cartridge 72 containing cyan (C) ink, a cartridge 73 containing magenta (M) ink, and a cartridge 74 containing yellow (Y) ink, are detachably mounted.

The print head 12 is provided on the bottom section of the carriage 31 and nozzle rows are formed in the print head 12. The nozzle rows each correspond to the different colors of ink, and in each nozzle row, nozzles which serve as ink ejecting sections are arranged in a row in the carrying direction of the print paper P.

Further, in each nozzle row, which is provided in the bottom section of the carriage 31 and which corresponds to each of the different kinds of ink, a piezoelectric element is arranged for each nozzle. The piezoelectric element is a type of an electrostrictive element and has a good responsiveness. The piezoelectric element is provided at a position where it contacts a member that forms an ink passage for guiding the ink to the nozzle.

The piezoelectric element causes deformation in the crystal structure when a voltage is applied and is thereby capable of performing conversion between electrical and mechanical energy at an extremely high speed.

In the present embodiment, by applying a voltage between electrodes provided on both ends of the piezoelectric element at predetermined time intervals, the piezoelectric element expands during the period of time in which the voltage is applied, and thus causes the wall of the ink passage on one side to deform.

As a result, the volume of the ink passage decreases according to the expansion of the piezoelectric element, and ink amounting to this volume decrease is ejected, as ink droplets, at high speed from the tip of the nozzle. The ink droplets soak into the print paper P that lies over the paper feed roller 26 to thereby form dots and perform printing. The size of the ink droplets can be varied by changing the way of applying the voltage to the piezoelectric element. Thus, it is possible, for example, to form dots in three different sizes, i.e., large, medium, and small.

The control circuit 40 is connected to the computer 90 via a connector 56. The computer 90 is an example of a feed amount correcting means, a dot recording ratio determining means, and a repeating means. As described further below, the computer 90 has installed a driver program for the printer 22 and serves as a user interface for accepting user commands that are input through operation of input devices, such as a keyboard and a mouse, and for presenting various kinds of information about the printer 22 by displaying a screen on a display device.

The sub-scan carrying mechanism for carrying the print paper P has a gear train (not shown) for transmitting the rotation of the paper feed motor 23 to the paper feed roller 26 and a paper carry roller (not shown).

Further, the main-scan carrying mechanism for moving the carriage 31 back and forth has: a slide shaft 34 that is bridged over the paper feed roller 26 in a direction parallel to the axis of the paper feed roller 26 and that slidably holds the carriage 31; a pulley 38 between which and the carriage motor 24 is stretched an endless drive belt 36; and an optical sensor 39 for detecting the position of origin of the carriage 31 and for detecting a correction pattern, which is described later. It should be noted that the optical sensor 39 is an example of a reading means and a detecting means. Furthermore, the optical sensor 39 is a part of a dot recording ratio setting means, which will be described later, and is constituted by a light source that emits light onto the print paper P, and a line sensor (or CCD elements) for converting the light reflected from the print paper P into corresponding image signals.

As shown in FIG. 2, the control circuit 40 is configured as an arithmetic logic circuit having a CPU (Central Processing Unit) 41, a programmable ROM (P-ROM (Read Only Memory)) 43, a RAM (Random Access Memory) 44, a character generator (CG) 45 storing dot matrix information about characters, and an EEPROM (Electronically Erasable and Programmable ROM) 46.

The control circuit 40 further includes: an I/F dedicated circuit 50 designed to serve as an interface (I/F) between, for example, external motors; a head drive circuit 52 that is connected to the I/F dedicated circuit 50 and that makes the print head unit 60 drive to eject ink; and a motor drive circuit 54 for driving the paper feed motor 23 and the carriage motor 24.

The I/F dedicated circuit 50 has inside a parallel interface circuit and is capable of receiving print signals PS supplied from the computer 90 via the connector 56.

===Configuration Example of Computer===

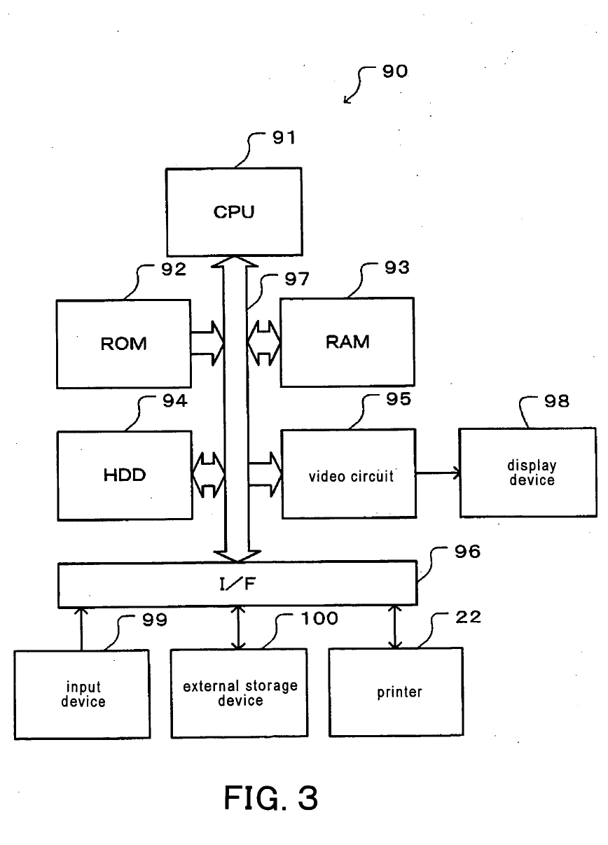

Next, the configuration of the computer 90 is described with reference to FIG. 3.

As shown in FIG. 3, the computer 90 is constituted by a CPU 91, a ROM 92, a RAM 93, a HDD (Hard Disk Drive) 94, a video circuit 95, an I/F 96, a bus 97, a display device 98, an input device 99, and an external storage device 100.

The CPU 91 is a controller for executing various computing processes according to programs stored in the ROM 92 or the HDD 94, and for controlling the various sections of the apparatus. As is described later, the CPU 91 is one part of the correction pattern printing means, and is one part of the dot recording ratio determining means. The CPU 91 can also function as a controller.

The ROM 92 is a memory that stores basic programs and data that are executed by the CPU 91. The RAM 93 is a memory that temporarily stores, for example, programs that are currently being executed by the CPU 91 and data that are being computed.

The HDD 94 is a recording device that reads out data and programs recorded on a hard disk, which is a recording medium, in response to requests from the CPU 91, and also records, onto the hard disk, data that have been generated as a result of the computing processes of the CPU 91.

The video circuit 95 is a circuit that executes drawing processes according to drawing commands that are supplied from the CPU 91, and that converts obtained image data into video signals to output them to the display device 98.

The I/F 96 is a circuit that appropriately converts the expression format of the signals that have been output from the input device 99 and the external storage device 100, and that outputs print signals PS to the printer 22.

The bus 97 is a signal line that mutually connects the CPU 91, the ROM 92, the RAM 93, the HDD 94, the video circuit 95, and the I/F 96, and that enables data exchange among these components.

The display device 98 is constituted by, for example, an LCD (Liquid Crystal Display) monitor or a CRT (Cathode Ray Tube) monitor, and is for displaying images corresponding to the video signals having been output from the video circuit 95.

The input device 99 is constituted by, for example, a keyboard and/or a mouse, generates signals in response to user operations, and supplies them to the I/F 96.

The external storage device 100 is structured, for example, of a CD-ROM (Compact Disk-ROM) drive unit, an MO (Magneto Optic) drive unit, or an FDD (Flexible Disk Drive) unit, reads out data and programs recorded on a CD-ROM disk, an MO disk, or an FD, and supplies them to the CPU 91. As for MO drive units and FDD units, the device 100 is also for recording the data supplied from the CPU 91 onto an MO disk or an FD.

===Configuration Example of Programs and Drivers===

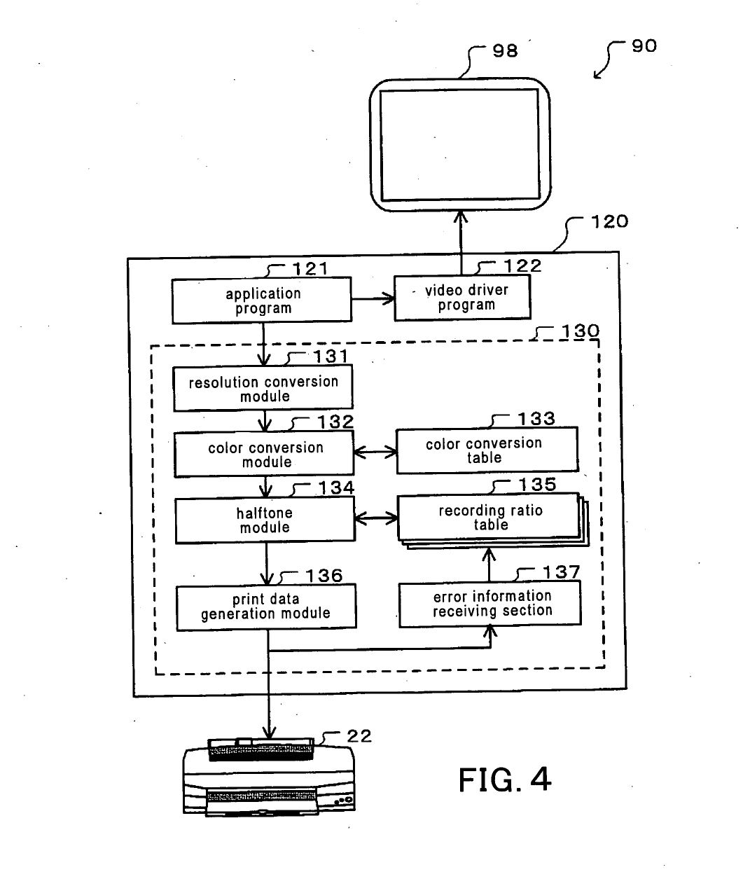

FIG. 4 is a diagram for explaining functions of programs and drivers that are installed in the computer 90. It should be noted that these functions are achieved by co-operation between the hardware of the computer 90 and the software that is recorded in the HDD 94. As shown in this diagram, an application program 121, a video driver program 122, and a printer driver program 130 are installed in the computer 90. These operate within a predetermined operating system (OS).

Here, the application program 121 is a program such as an image processing program that processes images taken by, for example, digital cameras, and images rendered by the user, after which they are output to the printer driver program 130 or the video driver program 122.

The video driver program 122 is a program for driving the video circuit 95. For example, image data that is delivered from the application program is gamma processed or white-balance adjusted, and then, the program generates an image signal and delivers it to the display apparatus 98 for display.

The printer driver program 30, which is one part of the correction pattern printing means, is constituted by a resolution conversion module 131, a color conversion module 132, a color conversion table 133, a halftone module 134, a recording ratio table 135, which is one part of a dot recording ratio determining means, a print data generation module 136, and an error information receiving section 137. The printer driver program 30 performs various processes that are explained later to generate print data out of image data generated by the application program 121, and sends the print data to the printer 22. Furthermore, the printer driver program 130 updates the recording ratio table 135, based on the print correction pattern (explained below) printed by the printer 22.

Here, the resolution conversion module 131 converts the resolution of the image data that is sent from the application program 121 in accordance with the resolution of the print head 12.

The color conversion module 132 refers to the color conversion table 133, and converts image data that is expressed according to the RGB (Red, Green, Blue) color system into image data in the CMYK (Cyan, Magenta, Yellow, Black) color system.

The halftone module 134 refers to the recording ratio table 135 to convert, using dithering described further below, the image data that is expressed in the CMYK color system into bitmap data that is formed from a combination of three types of dots: small, medium, and large.

The print data generation module 136 creates, from the bitmap data that is output from the halftone module 134, print data that includes raster data that indicates how the dots are recorded during each main scan, and data that indicates the sub-scan feed amount, and sends this to the printer 22.

The error information receiving section 137 receives data of the correction pattern that is detected by the printer 22 (error information), and sends it to the recording ratio table 135.

===Example of Overview of Overall Flow for Forming Dots===

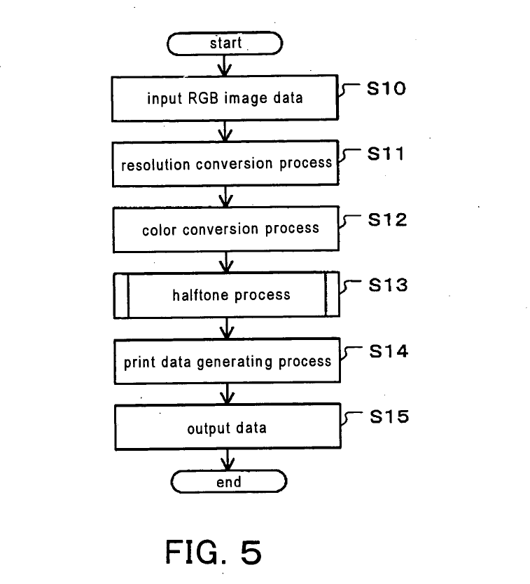

Next, a flow of a process through which dots are formed is described with reference to FIG. 5. This process is executed by the computer 90. When this flow is initiated, the steps described below are executed.

Step S10: The printer driver program 130 receives, from the application program 121, image data expressed in the RGB color system. It should be noted that the image data have gray-level values in 256 levels, i.e., made up of values 0 through 255, for each color of R, G, and B and for each pixel. Image data having gray-level values in 64 levels (0 through 63) or 32 levels (0 through 31) may be adopted, but in this example, data with gray-level values in 256 levels as described above are used in the explanation.

Step S11: The resolution conversion module 131 converts the resolution of the image data, which have been input, into the resolution of the printer 22 (which is referred to as “print resolution” below). If the resolution of the image data is lower than the print resolution, then resolution conversion is performed by generating new data between adjacent ones of original image data through interpolation such as linear interpolation. On the contrary, if the resolution of the image data is higher than the print resolution, then resolution conversion is performed, for example, by thinning out the image data at a predetermined rate.

Step S12: The color conversion module 132 performs a color conversion process. The color conversion process is a process for converting the image data that have gray-level values for each R, G, and B into multi-level data expressing gray-level values for each color of C, M, Y, and K that are used in the printer 22. This process is performed using the color conversion table 133 in which the colors made up by combinations of R, G, and B are recorded with combinations of C, M, Y, and K, which are expressed using the printer 22.

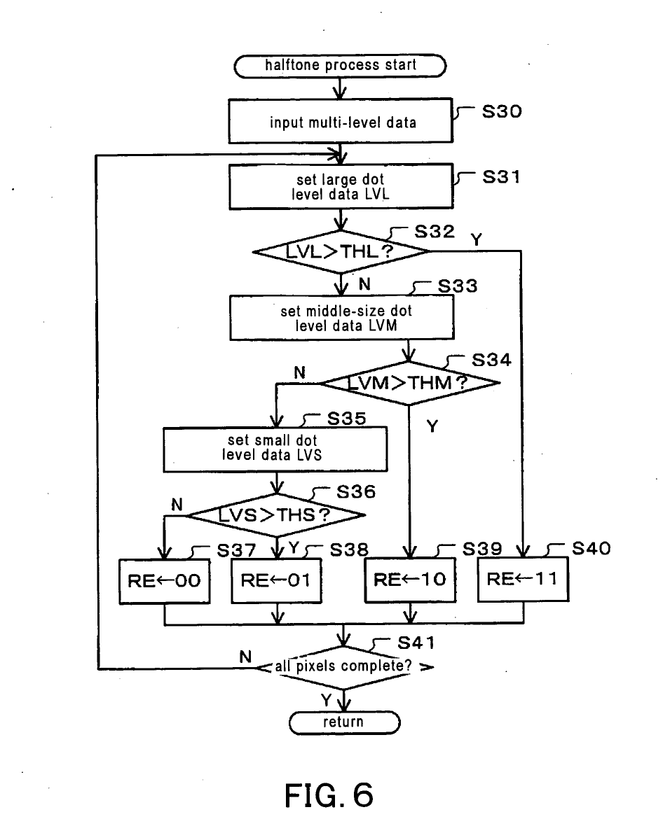

Step S13: The halftone module 134 performs a halftone process with respect to the image data that have been subjected to color conversion at step S12. The halftone process is a process for performing a decrease in color, i.e., for changing the gray-level values of the original image data (256 levels in the present embodiment) to gray-level values that can be expressed, for each pixel, by the printer 22. The term “decrease in color” means to decrease the number of levels in gray for expressing each color. It should be noted that in the present embodiment, a decrease in color to four levels —“no dot formed”, “form small dot”, “form middle-size dot”, and “form large dot”— is performed. The halftone process is illustrated later with reference to FIG. 6.

Step S14: The print data generating module 136 performs a process for generating print data from the bitmap data generated through the halftone process. Print data include raster data indicating the manner in which dots are to be recorded during each main-scanning movement, and data indicating the feed amount of sub-scanning movement.

Step S15: The print data generating module 136 outputs, to the printer 22, the print data that have been generated through the print data generating process. Then the process is ended.

===Details of Halftone Processing ===

Next, the halftone processing illustrated in step S13 in the flow chart in FIG. 5 is explained in more detail. FIG. 6 is a flow chart illustrating halftone processing in detail. When this flow chart is initiated, the following steps are executed.

Step S30: The halftone module 134 receives multi-level data from the color conversion module 132. The multi-level data that are input here are color converted (step S12 in FIG. 5) to data in which the colors C, M, Y and K are expressed by 256 gray-scale values.

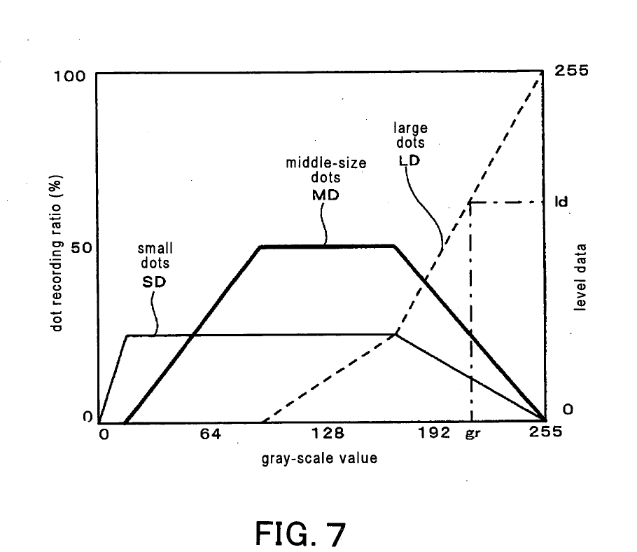

Step S31: The halftone module 134 sets the large dot level data LVL as described below, depending on the gray-scale of the image data. FIG. 7 is a diagram showing a plurality of recording ratio tables that are utilized for determining the level data of the large, middle-size, and small dots. The horizontal axis of FIG. 7 is the gray-scale values (0 to 255), the vertical axis on the left side is the dot recording ratio (%) and the vertical axis on the right side is the level data (0 to 255). Here, the “dot recording ratio” means the percentage of pixels at which dots are formed, from among the pixels in a uniform region, when that region is reproduced at a constant gray-scale value (in simpler terms, “the ratio at which dots are recorded per unit area”). The profile SD indicated by the narrow solid line in FIG. 7 shows the recording ratio of small dots, the profile MD indicated by the thick solid line shows the recording ratio of the medium-size dots, and the profile LD indicated by the dotted line shows the recording ratio of large dots. Furthermore, level data refers to data obtained by converting the dot recording ratio into 256 level values from 0 to 255. It should be noted that a method for setting the dot recording ratio table is explained later.

That is to say, in step S31, the level data LVL that correspond to the gray-scale value is read from the profile LD for large dots. For example, as shown in FIG. 7, if the gray-scale value of the multi-level data is gr, then the level data LVL is determined to be 1d using the profile LD. In practice,the profile LD is recorded in the RAM 93 as a one-dimensional table, and the level data is determined with reference to this table. This table is the recording ratio table 135 (see FIG. 4).

Step S32: The halftone module 134 determines whether or not the level data LVL that was set as described above is larger than a threshold value THL. Determination of whether a dot is on or off is made here, for example, according to the dither method. The threshold value THL is set to a different value for each pixel, in accordance with what is known as a dither matrix. The present embodiment uses a matrix that expresses values from 0 to 254 in a square 16×16 pixel block.

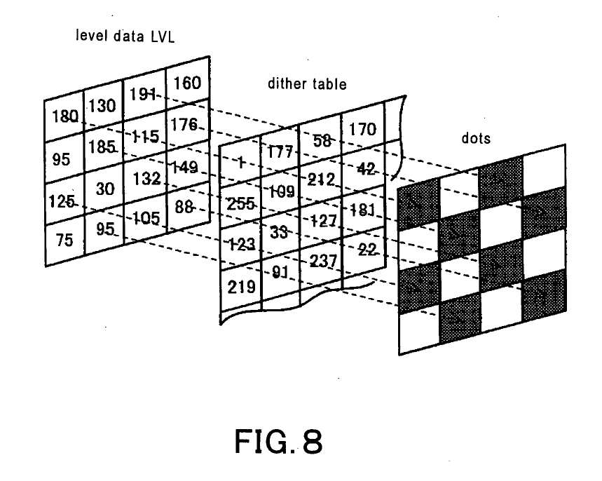

FIG. 8 is a diagram that shows how dots are to be judged on or off according to the dither method. For the purpose of convenience, only a part of the pixels is shown. As shown in FIG. 8, the largeness of each pixel of the level data LVL is compared to the value at the corresponding location in the dither table. If the level data LVL is larger than the threshold value THL that is shown in the dither table, then the dot is set to on, and if the level data LVL is smaller, then the dot is set to off. The hatched pixels in FIG. 8 indicate pixels in which the dot is set to on. If the level data LVL is larger than the threshold value THL, then the halftone module 134 advances to step S40, and in all other cases, the process advances to step S33.

Step S33: The halftone module 134 sets the level data LVM of middle-size dots. The level data LVM of middle-size dots is based on the gray-scale value, and is set according to the recording ratio table 135 previously described. The setting method is the same as for setting the level data LVL of large dots. That is to say, in the example shown in FIG. 7, the level data LVM is determined by 2d.

Step S34: The largeness of the level data LVM of the middle-size dots and the largeness of the threshold value THM are compared, and the middle-size dots are determined to be on or off. The method for on/off determination is the same as that for the large dots. However, as described next, the threshold value THM that is used in the determination is a value that is different to the threshold value THL used in the case of the large dots. That is to say, when the on/off determination is performed using the same dither matrix for the large dots and the small dots, then pixels where the dots tend to be on are the same in both cases. That is, there is a high possibility that when large dots are turned off, medium-size dots will also be turned off. As a result, there is a possibility that the recording ratio of the middle-size dots is lower than the desired recording ratio. In order to avoid such a phenomenon in the present embodiment, the dither matrices of both cases are set differently. That is, by changing the positions of the pixels that tend to be on for the large dots and the medium-size dots, it is possible to ensure that the large dots and the medium-size dots are formed appropriately.

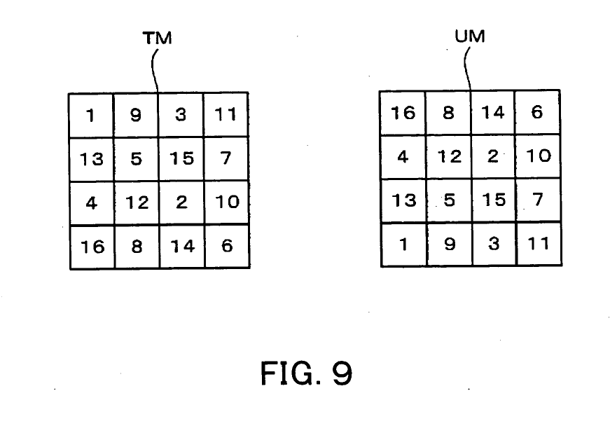

FIG. 9 is a diagram showing a relationship between the dither matrix used to judge the large dots, and the dither matrix used to judge the middle-size dots. In this embodiment, as shown in FIG. 9, a first dither matrix TM is used for the large dots, and a second dither matrix UM that is obtained by mirroring these threshold values symmetrically at the center in the sub-scanning direction is used for the middle-size dots. As explained previously, the present embodiment uses a 64×64 matrix, but for convenience of illustration, FIG. 9 shows a 4×4 matrix. It should be noted that it is also possible to use a large dot dither matrix and a middle-size dot dither matrix that are completely different from each other.

Then, if the level data LVM of a middle-size dot is larger than the threshold value THM, then it is judged that the middle-size dot is to be turned on, and the process advances to step S39, while in all other cases, it advances to step S35.

Step S35: The level data LVS of the small dots are set in a similar manner to that in which the level data of the large dots and the middle-size dots were set. It should be noted that it is preferable that in order to suppress reductions in the recording ratio of small dots, the dither matrix for small dots is different from those for middle-size dots and large dots, as described previously.

Step S36: If the level data LVS is larger than the threshold value THS for small dots, then the halftone module 134 advances to step S38, and otherwise it advances to step S37.

Step S37: The halftone module 134 judges that no dot is to be formed, and stores the binary value “00” in a variable RE storing the result value.

Step S38: The halftone module 134 judges that a small dot is to be on, and stores the binary value “01” in the variable RE storing the result value.

Step S39: The halftone module 134 judges that a middle-size dot is to be on, and stores the binary value “10” in the variable RE storing the result value.

Step S40: The halftone module 134 judges that a large dot is to be on, and stores the binary value “11” in the variable RE storing the result value.

Step S41: Since the process above makes a judgment about which dot should be formed in a single pixel, the halftone module 134 repeats steps S31 to S40 until processing of all pixels is completed. When processing of all pixels is finished, halftone processing (step S13) concludes, and the procedure returns to the print data generating process (step S14).

===Adjusting Printers Capable of Forming Dots of a Plurality of Sizes===

The following is an explanation of a method for adjusting banding and the like, in printers that are capable of forming dots of a plurality of sizes. In the present embodiment, the printer is adjusted by appropriately setting the contents of the recording ratio table 135 described above.

<Setting the Recording Ratio Table 135>

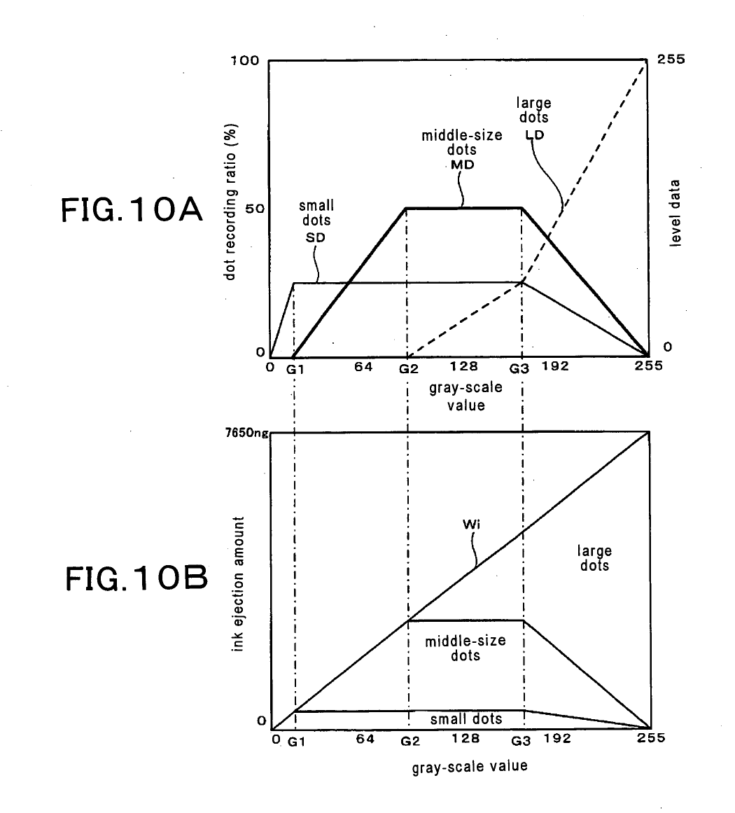

FIG. 10A and FIG. 10B are diagrams showing a relationship between the recording ratio table 135 and the ink ejection amount. FIG. 10A is a diagram showing a relationship between gray-scale values of multi-level data and the dot recording ratio for dots of each size, and is the same as FIG. 7. FIG. 10B is a diagram showing a relationship between gray-scale values, and the weight of ink that is ejected onto a predetermined region. The predetermined region is defined as a region that is constituted by 255 pixels. As for the ink weight, the small dots are set to 10 ng, the middle-size dots are set to 20 ng, and the large dots are set to 30 ng.

More specifically, FIG. 10B is a plot of the product of each of the values of (1), (2) and (3) described below, at each gray-scale value.

(1) The recording ratio of dots of each size (for example, the value of a small dot at the gray-scale value G2 is 25%, and the value of a middle-size dot is 50%).

(2) The weight of ink (small dots are 10 ng, middle-size dots are 20 ng and large dots are 30 ng).

(3) The number of pixels in a predetermined region (255 pixels).

For example, if the gray-scale value is 255 (maximum gray-scale value), then the product is 7650 ng (=100%×30 ng×255 pixels).

In FIG. 10B, as the gray-scale values increase from “0” to “255”, the ink ejection amount increases from 0 ng to 7650 ng along to a straight line Wi. Accordingly, in order to simplify the explanation of the present embodiment, the weight of ink that is ejected onto the predetermined region is set to have a linear relationship with the gray-scale values.

The weight of ink that is ejected onto the predetermined region increases as shown in FIG. 10A and FIG. 10B in accordance with an increase in gray-scale value as described below.

(1) In the region from the gray-scale value of “0” to gray-scale value G1, the weight of ink increases linearly in accordance with an increase in the recording ratio of the small dots. This region is occupied solely by small dots.

(2) In the region from the gray-scale value G1 to a gray-scale value G2, the dot recording ratio of small dots is constant, and the ink weight increases linearly in accordance with an increase in the dot recording ratio of the middle-size dots. This region is constituted by small dots and middle-size dots.

(3) In the region of the gray-scale value G2 to a gray-scale value G3, the recording ratio of small dots and middle-size dots is constant, and the weight of ink increases linearly in accordance with an increase in the dot recording ratio of the large dots. This region is constituted by three types of dots: small dots, middle-size dots and large dots.

(4) In the region from the gray-scale value G3 up to the maximum gray-scale value, the dot recording ratio of the small dots and the middle-size dots decreases, and the ink weight increases linearly by replacing the small dots and the middle-size dots with large dots. This region is also constituted by small dots, middle-size dots and large dots.

It is necessary to determine such a profile of dot recording ratios in consideration of the trade-off described below.

(1) In order to suppress graininess (image roughness), it is preferable to lower the dot recording ratio of relatively large dots, which tend to be visible, and increase the dot recording ratio of relatively small dots. This characteristic is particularly noticeable in the low gray-scale region.

(2) In order to reduce banding (line-shaped deterioration of image quality), it is preferable to lower the dot recording ratio of relatively small dots, by substituting relatively large dots for the relatively small dots. This characteristic is particularly noticeable in the high gray-scale region.

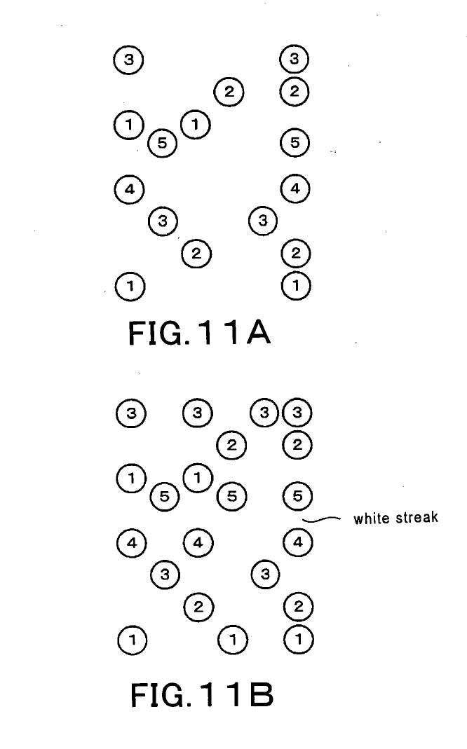

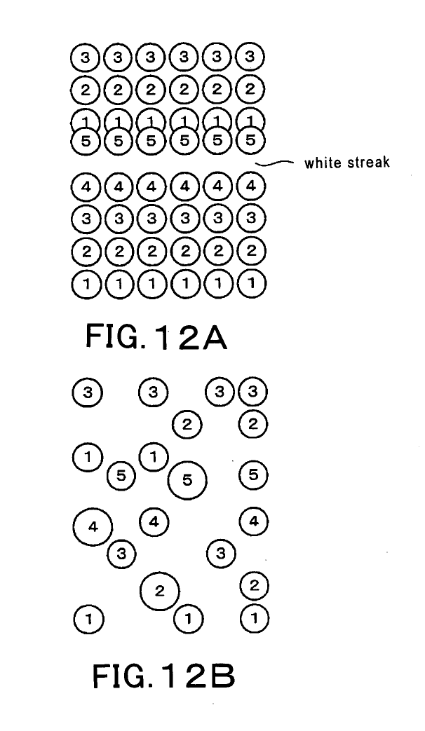

FIG. 11A, FIG. 11B, FIG. 12A and FIG. 12B are diagrams showing a relationship between dot recording ratio and banding. FIG. 11A shows a state in which small dots are printed at a dot recording ratio of 33% in an 8×6 matrix. FIG. 11B shows a state in which small dots are printed at a dot recording ratio of 44% in a similar 8×6 matrix. Further, FIG. 12A shows a state in which small dots are recorded at a 100% dot recording ratio. It should be noted that numbers within the circles in these diagrams indicate the number of the nozzle that formed the dot. In this example, the dots that are formed by the number 5 nozzle are shifted upward due to a manufacturing error, for example.

As is made clear from these diagrams, white streaks are not particularly noticeable when the dot recording ratio is 33%, but it starts to become a little noticeable when this ratio is at a level of 44%, and is very noticeable at a level of 100%. Furthermore, FIG. 12B shows a condition in which some of the dots in FIG. 11B are substituted by middle-size dots. In this case, since the middle-size dots are formed in the section in which the white streak, which was caused by the number 4 nozzle and the number 5 nozzle, occurred in FIG. 11B, the white streak is fragmented by these dots, and thus, is not noticeable.

Accordingly, in order to suppress the occurrence of banding such as white streaks, it is preferable to perform printing by replacing dots in the vicinity of a dot recording ratio that has noticeable banding with dots of a relatively large size. However, it is preferable that the level of recording ratio at which substitution should be made is set individually, depending on the error characteristics of the printer and the object to be printed and the like.

In view of the above, the present embodiment uses a method such as that described below to set the timing for changing the dot sizes.

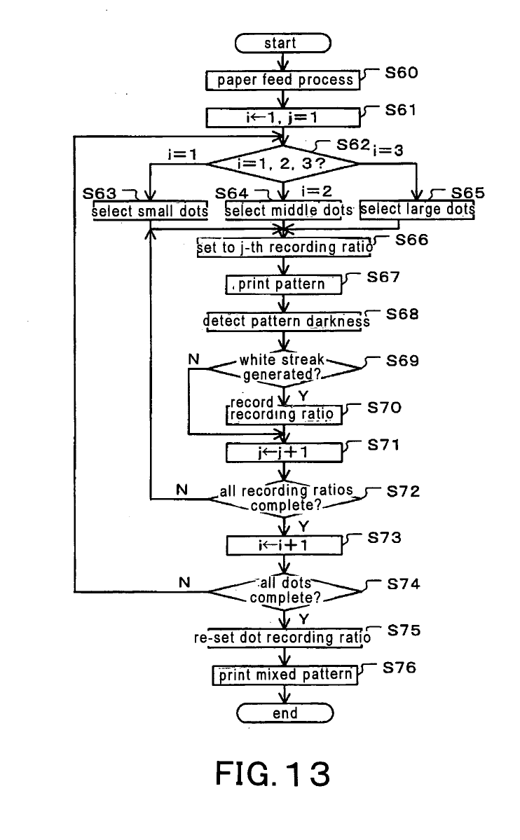

FIG. 13 is a flow chart for explaining the flow of a process for setting the recording ratio table 135 (see FIG. 4), which determines the timing of the change between dot sizes. When this flow chart is initiated, the steps below are executed.

Step S60: The CPU 91 sends a control command to the control circuit 40 of the printer 22, and instructs it to feed one piece of print paper P. As a result, the control circuit 40 drives the paper feed motor 23 and a paper supply motor, which is not shown, and feeds a single piece of print paper P.

Step S61: The CPU 91 sets initial values of a variable i and a variable j, which are for counting the number of times of processing, to “1”.

Step S62: If the value that is stored in a variable i is “1”, then the CPU 91 branches to step S63, if the value of i is “2” then the CPU 91 branches to step S64, and if the value of i is “3” then the CPU 91 branches to step S65.

Step S63: The CPU 91 selects small dots as the dots to be printed. That is to say, the value of the variable i being “1” is equivalent to the value of the variable RE being “01” in the previous example.

Step S64: The CPU91 selects middle-size dots as the dots to be printed. At this time, the value of the variable i being “2” is equivalent to the value of the variable RE being “10” in the previous example.

Step S65: The CPU91 selects large dots as the dots to be printed. Accordingly, the value of the variable i being “3” is equivalent to the value of the variable RE being “11” in the previous example.

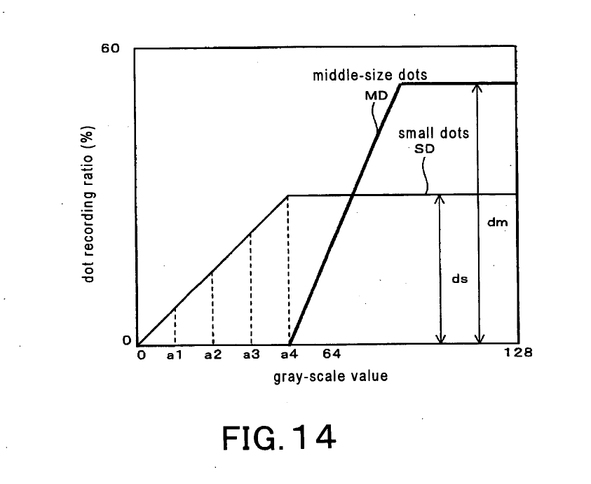

Step S66: The CPU 91 sets the j-th recording ratio to be the recording ratio at which the print correction pattern is printed. The print correction pattern is explained later. For example, using small dots as an example for the explanation, since the dot recording ratio of small dots is set to a value from “0%” to “ds %” depending on the gray-scale value as shown in FIG. 14, four sample points a1 to a4 are selected from this zone, and are taken respectively as the first through fourth recording ratios. The occurrence of white streaks is observed by printing a pattern at each of the first through fourth recording ratios, as explained later. For example, if j=1, then the print correction pattern is set to the first recording ratio (that is, the dot recording ratio at al in FIG. 14).

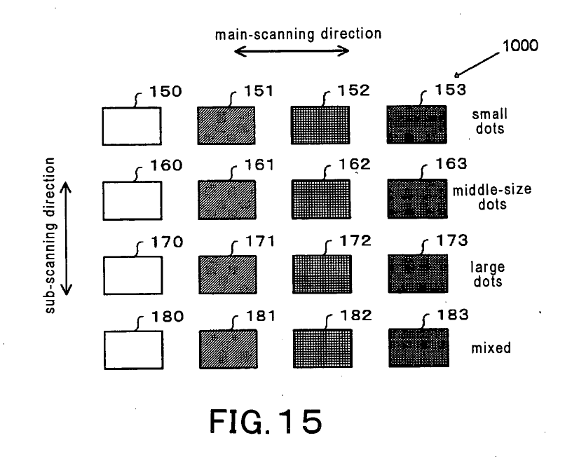

Step S67: The CPU 91 provides data for printing the print correction pattern to the printer driver program 130. As a result, a pattern in accordance with the recording ratio that was set in Step S66 is printed by the printer 22. FIG. 15 is a diagram showing an example of a print correction pattern 1000 printed at this time. In the example of this diagram, in the uppermost row, the recording ratio is set so as to increase in succession from left to right and patterns 150 to 153, which are printed using only small dots, are printed. Similarly in the second row, patterns 160 to 163, which are printed using only middle-size dots, are printed, and in the third row, patterns 170 to 173, which are printed using only large dots, are printed. In the fourth row, patterns 180 to 183, which are printed using a mixture of large, middle-size and small dots are printed. It should be noted that in this example the pattern 150 is printed, because j=1 and i=1.

Step S68: CPU 91 transmits a command to the printer 22 to detect the darkness of the pattern that was printed just previously. As a result, the control circuit 40 of the printer 22 drives the carriage motor 24 and moves the carriage 31 in the main-scanning direction, scanning the pattern that was just previously printed to detect the darkness of that pattern using the optical sensor 39.

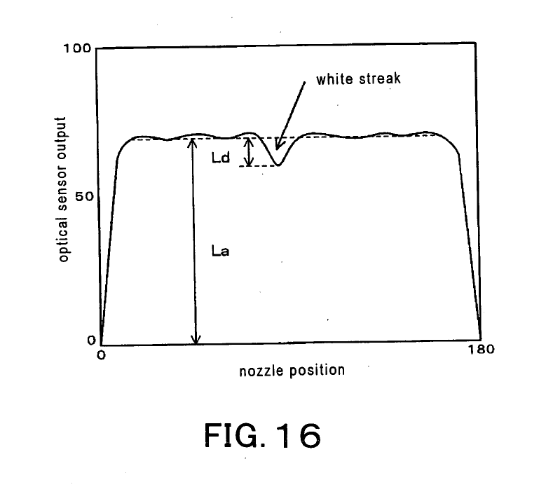

FIG. 16 is a diagram showing an example of a signal that is output from the optical sensor 39 at this time. The horizontal axis in this diagram shows the position of the nozzles that are provided on the print head 12, and the horizontal axis shows the output from the optical sensor 39. More specifically, the optical sensor 39 has, for example, line sensors arranged in a row the sub-scanning direction, and the line sensors convert light that is reflected from the pattern into an electric signal. In the present embodiment, if the intensity of reflected light from the print paper P is high, then the value of the electric signal that is obtained is small, and if the intensity is low, then the value is large. Therefore, if a white streak occurs in the pattern, the level of a portion of the output from the line sensors of the optical sensor 39 becomes lower than other portions, as shown in FIG. 16. Thus, the occurrence of white streaks can be detected by detecting such portions (referred to below as “subsided portions”).

Step S69: With reference to the output signal for the optical sensor 39, the CPU 91 calculates the ratio (Ld/La) between an average signal level La to a level Ld of the subsided portion, and if this ratio is equal to or larger than a predetermined value (for example 10%), then it is determined that a white streak has occurred. And, if it is determined that a white streak has occurred, then the process advances to step S70, and otherwise the process advances to step S71.

Step S70: The CPU 91 stores the dot recording ratio at the time at which the white streak is detected in the RAM 93.

Step S71: The CPU 91 increments the value of the variable j, which is for counting the number of times of processing, up by 1.

Step S72: The CPU 91 determines whether or not processing of all recording ratios are complete. If it is not complete then it returns to step S66 and repeats the same process, and otherwise it advances to step S73. For example, in the case of small dots, if all the patterns 150 to 153 at the first to the fourth dot recording ratios (the recording ratios corresponding to al to a4) are finished as explained previously, then the process advances to step S73, and in all other cases, the process returns to step S66 and printing of the patterns is repeated.

Step S73: The CPU 91 increments the variable i, which indicates the dot type, by 1. Thus, the process advances to the middle-size dot patterns 160 to 163. If, for example, there are four print dot recording ratios of middle-size dots, then the patterns 160 to 163 are printed, and the recording ratio at which white streaks occurred is recorded. Then, the variable i is advanced again by 1. And then, the large dot patterns 170 to 173 are printed.

Step S74: The CPU91 determines whether or not processing of all the dots is complete. If it is not complete, the process returns to step S62 and the same processing is repeated, and otherwise the process advances to step S75. Specifically, if printing of the patterns of all the small, middle-size and large dots is complete, then the process advances to step S75, and in all other cases the process returns to step S62, and printing of the patterns is repeated.

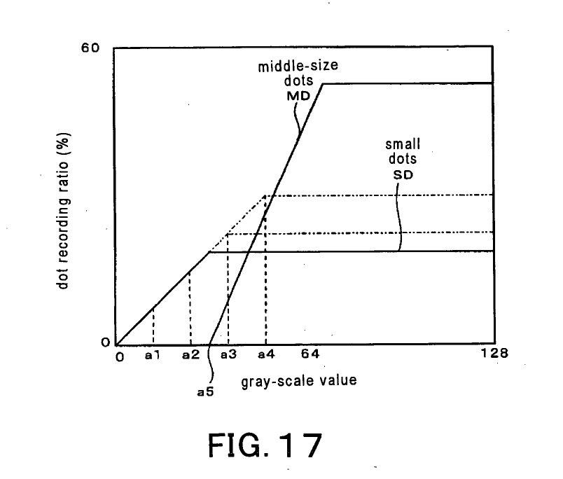

Step S75: The CPU 91 executes a process to set the recording ratio table 135 again. For example, if a white streak is detected at the point a3 in FIG. 14, then it is necessary to increase the rate of generation of middle-size dots at a point that has a gray-scale lower than that of a3. Thus, as shown in FIG. 17, an upper limit for the recording ratio of small dots is set at a point a5 that is between the point a2 and a3, and furthermore, the profile for the middle-size dot is set such that the middle-size dots are generated starting from a5. As a result, while the small dots are regularly printed at recording ratios lower than the recording ratio a3 at which white streaks occur, it is possible to suppress white streak generation since middle-size dots are always mixed at the gray-scale value a3, at which white streaks occur when only small dots are used. It should be noted that a similar process is performed between middle-size dots and large dots. Thus, adjustment of the new recording ratio table 135 settings is completed by the process above.

Step S76: The CPU 91 uses the newly set recording ratio table 135 to print the pattern that utilized all the small, middle-size and large dots. As a result, the patterns 180 to 183 that are shown in FIG. 15 are printed on the print paper P. By referring to patterns such as the patterns 180 to 183, the user, or an operator of the manufacturing process who makes these settings, can confirm whether or not occurrence of the white streaks is suppressed. It should be noted that at this time it is also possible to reprint together the patterns of each dot size, namely the patterns 150 to 153, the patterns 160 to 163 and the patterns 170 to 173.

According to the embodiment above, the patterns 150 to 153, 160 to 163, 170 to 173 and 180 to 183 of the print correction pattern 1000, were printed while varying individual dot recording ratios in the printer 22 which contains three types of dot sizes—small, middle-size and large—, and the recording ratio table 135 is re-set by referring to these. Accordingly, the recording ratio table 135 can be set optimally for each printer 22. As a result, the occurrence of banding such as white streaks can be reliably suppressed. Furthermore, since it is possible to set the timing of the change between dot sizes at a point that is to the very limit of the non-generation of white streaks, excellent image quality with low graininess can be obtained by preferentially selecting smaller dots.

<Other Considerations>

An embodiment of the present invention was explained above, but various other modifications of the present invention are possible. For example, the foregoing embodiment prints four types of patterns of each dot size for each pattern 150 to 153, 160 to 163, 170 to 173 and 180 to 183 of the print correction pattern 1000. It is, however, also possible to print more or fewer patterns. For example, if no more than three types of patterns are printed, it is possible to reduce the printing time compared to printing four patterns. Furthermore, if five or more patterns are printed, then it is possible to determine the dot change-over point (for example, a5 shown in FIG. 17) with greater accuracy.

Furthermore, the foregoing embodiment changes the recording ratio table 135 used for the entire image depending on the manner in which white streaks occur. It is, however, also possible to prepare, for example, a recording ratio table that is used only for the nozzle that generates white streaks, or only for that nozzle and one or two or more other nozzles in its vicinity, and change only that recording ratio table. In this way, although there is an increased process load because it is necessary to use a plurality of recording ratio tables, the white streaks can be reliably suppressed without changing the image quality of the entire image because adjustments can be made simply by changing the settings of the nozzle that generates white streaks, or only that nozzle and one or two or more other nozzles in its vicinity.

Furthermore, in the foregoing embodiment, the optical sensor 39 that is provided on the printer 22 is used to detect each pattern 150 to 153, 160 to 163, and 170 to 173 of the print correction pattern 1000. However, an optical scanner, for example, that can be connected to the computer 90 may also be used for converting them to electric signals, and reading them in. According to such an embodiment, even in a case in which the printer 22 does not have an optical scanner 39, the dot recording ratio can be set to an optimum value.

Furthermore, in the foregoing embodiment, the patterns 150 to 153, 160 to 163, and 170 to 173 of the print correction pattern 1000 are read in with the optical sensor 39, and the recording ratio table 135 is set automatically. However, for example, the recording ratio table 135 may also be set manually while referring to the detection result from the optical sensor 39. According to this type of method, it is also possible to consider increases and decreases of graininess, and the recording ratio table 135 can be set optimally while the user or the like actually confirms the condition with his/her own eyes.

Furthermore, in the foregoing embodiment, the upper limit of the dots targeted for adjustment is set at a dot recording ratio that is smaller than the dot recording ratio at which banding is detected. However, as shown by the alternate long-and-short dashed lines in FIG. 17, it is also possible to set the upper limit of the small dots to a value that is the same as or larger than the dot recording ratio at which banding is detected. Furthermore, it is also possible to set the starting point for larger dots to a value that is the same as or larger than the dot recording ratio at which banding is detected. More specifically, in FIG. 17, it is also possible to set the point a5, which is the point at which middle-size dots start to be formed, to be at the point a3, or a point greater than a3. Even in a case that is set in such a manner, as shown in FIG. 12B, substitution of the dots occurs and banding is reduced. Furthermore, with such settings, graininess can be reduced by increasing the recording ratio of small-sized dots compared to the case of FIG. 17.

===Adjustment of Interlace Method Printers that Form Dots of a Plurality of Sizes===

The following is an explanation of a method for adjusting banding and the like in interlace method printers that are capable of forming dots of a plurality of sizes. In the present embodiment, the printer is adjusted first by correcting the paper feed amount, and then by appropriately setting the contents of the above-described recording ratio table 135.

<Correction of the Paper Feed Amount>

First, a process for correcting the paper feed amount is described.

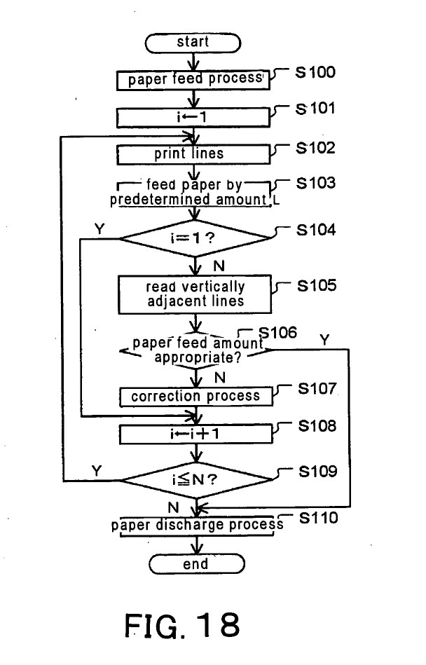

FIG. 18 is a flow chart for explaining an example of the process for correcting the paper feed amount. When this flow chart is initiated, the process below is executed.

Step S100: The CPU 91 sends a paper supply command to the printer 22. As a result, the control circuit 40 of the printer 22 drives the paper supply motor, which is not shown, and the paper feed motor 23, and supplies just a single piece of print paper P from the paper supply tray.

Step S101: The CPU 91 substitutes “1” as the initial value of the variable i, which is for counting the number of times of processing.

Step S102: The CPU 91 sends to the printer driver program 130 a command requesting to print lines that have a predetermined length in the main-scanning direction, and have a predetermined width in the sub-scanning direction. As a result, the control circuit 40 causes ink to be ejected from predetermined nozzles (for example the nozzle positioned at the uppermost position of black (K)) on the print head 12, to render the lines. It should be noted that when printing the lines in subsequent processes, the lines are rendered using the same nozzle.

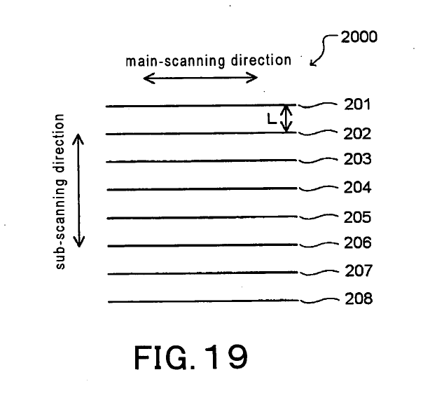

FIG. 19 is a diagram that shows an example of lines 201 to 208, which constitute a paper feed correction pattern 2000 that is printed at this time. For example, if i=1, then line 201 is printed, and if i=2, 3, . . . , 8, lines 202 to 208 are printed respectively.

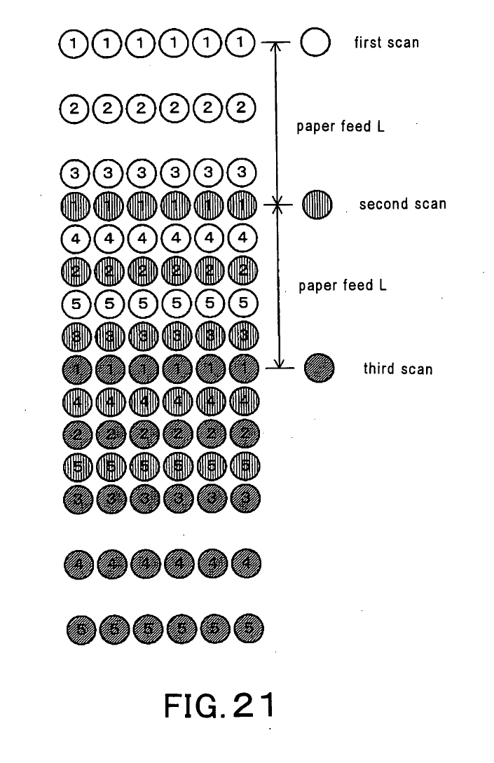

Step S103: The CPU 91 instructs the printer 22 to feed the paper by a predetermined amount L (see FIG. 19). It should be noted that this amount L corresponds to a paper feed amount (see FIG. 21) when printing by the interlace method. As a result, the control circuit 40 drives the paper feed motor 23 and feeds the print paper P by the predetermined amount L.

Step S104: The CPU 91 determines whether the variable i, which is for counting the number of times of processing, is “1” or not. If it is “1”, then this means that it is the initial process, and the CPU determines that only a single line has been printed and advances to step S108. Otherwise the process advances to step S105.

Step S105: The CPU 91 causes the optical sensor 39 to read the lines that are vertically adjacent to one another, that is, the line that was newly printed by the process in the step S102, and the line that was printed by the process one count previously. It should be noted that the optical sensor 39 has a sufficient length (length in the sub-scanning direction) to read in the two vertically-adjacent lines in one scan, and the electric signals that correspond to the lines that were read in by the optical sensor 39 are sent to the CPU 91.

Step S106: With reference to the distance between the lines that were read in step S105, the CPU 91 determines whether or not the paper feed amount is appropriate, and if it is appropriate, then it advances to step S110, and otherwise it advances to step S107. It should be noted that in order to determine whether or not the paper feed amount is appropriate, it is determined whether the distance between the line just printed and the line that was printed according to the process one count previous is appropriate, that is, whether or not the distance between the light receptive elements that detected these lines is appropriate, referring to the electric signal that is delivered from the optical sensor 39.

Step S107: The CPU 91 updates the set value such that the paper feed amount of the print data generation module 136 becomes appropriate. That is to say, if the paper feed amount is more than the prescribed value, then the set value is reduced by a predetermined amount, and if the paper feed amount is less than the prescribed value, then the set value is increased by a predetermined amount.

Step S108: The CPU 91 increments the value of the variable i, which is for counting the number of times of processing, up by “1”.

Step S109: The CPU 91 determines whether or not the value of the variable i is less than or equal to a predetermined constant N (for example N=10). If YES, then the process return to step S102, and the same process is repeated. If NO, then the process advances to step S110.

Step S110: The CPU 91 sends a command instructing the printer 22 to discharge the print paper P. As a result, the control circuit 40 of the printer 22 drives the paper feed motor 23, and discharges the print paper P.

By the foregoing process, the paper feed amount L can be set correctly.

<Setting the Recording Ratio Table 135>

The following is an explanation of a method for setting the recording ratio table 135. It should be noted that since the contents of the recording ratio table 135 and the relationship between the dot recording ratio and the banding have already been explained using FIG. 10A, FIG. 10B, FIG. 11A, FIG. 11B, FIG. 12A and FIG. 12B, further description thereof is omitted below.

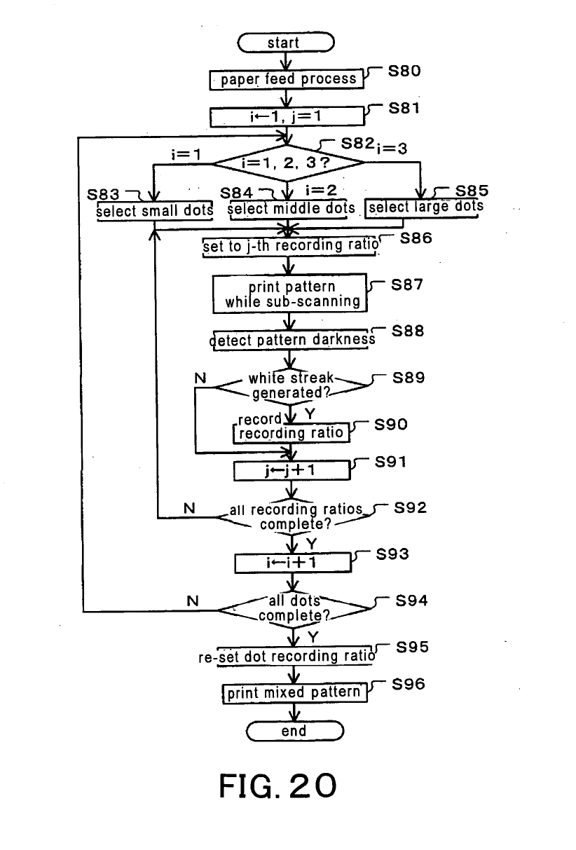

FIG. 20 is a flow chart of the present example illustrating the flow of the process for setting the recording ratio table 135 (see FIG. 4), which determines the timing for changing the dot sizes. Since the steps S80 to S96 in the flow chart of FIG. 20 (except for step S87) are respectively the same as the steps S60 to S76 that were already explained using FIG. 13, further description thereof is omitted below.

It should be noted that step S87 in the flow chart of FIG. 20 differs from step S67 in the flow chart in FIG. 13 in terms that each of the patterns in the print correction pattern 1000 is printed not by a single scan, but by a plurality of passes at a predetermined paper feed amount L.

Furthermore, the print correction pattern that is printed in step S87 is the same as the print correction pattern 1000 that is shown in FIG. 15. It should be noted that it is also possible to print each pattern 150 to 153, 160 to 163, 170 to 173 and 180 to 183 of the print correction pattern 1000 that is shown in FIG. 15 using ink of each color, and to make a correction for each color.

By carrying out the process that is shown in the flow chart of FIG. 20, it is possible to eliminate most of the banding. However, if, for example, the occurrence of banding cannot be eliminated just by correcting the recording ratio because the paper feed error cannot be completely removed due to factors such as detection errors of the optical sensor 39, then it is also possible to adjust the paper feed amount again by returning to the flow chart shown in FIG. 18. In this case, if, for example, banding that is caused by a low darkness portion is detected, that is, if a portion of high reflectance of light (white streak) is detected by the optical sensor 39, then the target value of the paper feed amount is set slightly smaller than the current value, and the process shown in FIG. 18 is repeated. With this method, it is possible to eliminate the occurrence of banding even if there are detection errors that are caused by, for example, the optical sensor 39. It should be noted that in cases in which banding that is caused by portions that have high darkness is detected, this usually does not often cause problems because it is usually eliminated by lowering the dot recording ratio. However, in cases in which the problem cannot be eliminated even if the dot recording ratio is lowered, then the target value of the paper feed amount is set slightly higher than the current value, for example, and the process that is shown in FIG. 18 can be repeated.

It should be noted that generally, paper feed errors cannot be completely eliminated due to factors such as the accuracy of the optical sensor 39. However, according to the present invention, even when paper feed errors are included to some extent, it is possible to prevent the occurrence of banding, including those caused by the paper feed errors, by correcting the dot recording ratio.

According to the foregoing embodiment, after printing the feed amount correction pattern 2000 that is shown in FIG. 19 and correcting the feed amount, each pattern 150 to 153, 160 to 163, 170 to 173 and 180 to 183 of the print correction pattern 1000 is printed with varied dot recording ratios for each dot size, and the recording ratio table 135 is set again with reference to these. In this way, it is possible to prevent the occurrence of banding caused by errors in feed amount, and it is also possible to suppress the generation of banding caused by nozzle errors. Furthermore, since it is possible to set the timing for changing the dot sizes to a point that is at the very limit of non-generation of white streaks, it is possible to obtain excellent image quality having minimal graininess by preferentially selecting smaller dots.

<Other Considerations>

An embodiment of the present invention was described above, but the present invention can be modified in various ways. For example, in the foregoing embodiment, four types of patterns for each dot size were printed as the patterns 150 to 153, 160 to 163, 170 to 173 and 180 to 183 of the print correction pattern 1000. However, it is also possible to print more or fewer patterns. For example, if three or fewer patterns are printed, it is possible to shorten the pattern-printing time compared to that of four patterns. Furthermore, if five or more patterns are printed, it is possible to determine the dot change-over point (for example, a5 shown in FIG. 17) with greater accuracy.

Furthermore, in the foregoing embodiment, the dot recording ratio is corrected according to the print correction pattern 1000 for correcting the dot recording ratio after correcting the paper feed amount according to the feed amount correction pattern 2000 for correcting the paper feed amount, but it is also possible to print only the pattern 2000 for correcting the paper feed amount described above and correct only the paper feed amount.

Furthermore, in the foregoing embodiment, the feed amount correction pattern 2000 for correcting the paper feed amount that is shown in FIG. 19, and the print correction pattern 1000 for determining the dot recording ratio that is shown in FIG. 15 are printed on separate print papers P, but it is also possible to record these on a same piece of print paper, and print a correction pattern that includes the two patterns 1000 and 2000. According to this method, it is possible to prevent wasteful consumption of the print paper P.

Furthermore, in the foregoing embodiment, no particular reference was made as regards the color of the ink for printing the print correction pattern 1000 that is shown in FIG. 15. However, it is possible to print this using only a specific color (for example, black (K)), or it is possible to print the print correction pattern 1000 in each color. In the former case, by using ink (black (K) ink) that has a high light absorption rate, it is possible to detect printing non-uniformities with a high degree of precision. Furthermore, in the latter case, by determining the dot recording ratio of each color, it is possible to obtain a high quality image that has no printing non-uniformities of any color.

Furthermore, the foregoing embodiment updates the recording ratio table 135 used for the entire image depending on the manner in which white streaks occur. However, it is also possible to prepare, for example, a recording ratio table that is used only for the nozzle that generates white streaks, or only for that nozzle and one or two or more other nozzles in its vicinity, and to update only that recording ratio table. In this way, although there is an increased process load because it is necessary to use a plurality of recording ratio tables, the white streaks can be reliably suppressed without changing the image quality of the entire image because adjustments can be made simply by updating the setting of the nozzle that generates white streaks, or only that nozzle and one or two or more other nozzles in its vicinity.

Furthermore, in the foregoing embodiment, the feed amount correction pattern 2000 is constituted by lines. However, since it is possible to use any pattern by which the feed amount can be read, there is no limitation to lines, and patterns, such as block-shapes that have a predetermined width can also be used.

Furthermore, in the foregoing embodiment, the optical sensor 39 that is provided on the printer 22 is used to detect each pattern 150 to 153, 160 to 163, 170 to 173 and 180 to 183 of the print correction pattern 1000. However, an optical scanner, for example, that can be connected to the computer 90 may also be used for converting them into electric signals, and reading them. According to such an embodiment, even in a case in which the printer 22 does not have an optical scanner 39, the dot recording ratio can be set to an optimum value.

Furthermore, in the foregoing embodiment, the patterns 150 to 153, 160 to 163, 170 to 173 and 180 to 183 of the print correction pattern 1000 are read with the optical sensor 39, and the recording ratio table 135 is set automatically. However, the recording ratio table 135 may also be set manually while referring to the detection result from the optical sensor 39. According to this type of method, it is also possible to consider increases and decreases of graininess, and the recording ratio table 135 can be set optimally while the user or the like actually confirms the condition with his/her own eyes.

Furthermore, in the foregoing embodiment, the upper limit of the dots targeted for adjustment is set at a dot recording ratio that is smaller than the dot recording ratio at which banding is detected. However, as shown by the alternate long-and-short dashed lines in FIG. 17, it is also possible to set the upper limit of the small dots to a value that is the same as or larger than the dot recording ratio at which banding is detected. Furthermore, it is also possible to set the starting point for larger dots to a value that is the same as or larger than the dot recording ratio at which banding is detected. More specifically, in FIG. 17, it is also possible to set the point a5, which is the point at which middle-size dots start to be formed, to be at the point a3, or a point greater than a3. Even in a case that is set in such a manner, as shown in FIG. 12B, substitution of the dots occurs and banding is reduced. Furthermore, with such settings, graininess can be reduced by increasing the recording ratio of small-sized dots compared to the case of FIG. 17.

===Other Embodiments===

An image forming apparatus, for example, according to the present invention was described above in accordance with one embodiment, but the foregoing embodiment of the invention is for the purpose of elucidating the present invention and is not to be interpreted as limiting the present invention. The present invention can of course be altered and improved without departing from the gist thereof and includes equivalents thereof.

In the foregoing embodiment, a relationship (that is to say, a profile) between the gray-scale value and the dot recording ratio for a plurality of dot types (N types; three types in the example described above: small, middle-size and large) is modified. However, the present invention is not limited to such embodiments. For example, the present invention can also be applied to printing apparatuses that can only form dots of the same size. In this case, it is also possible (1) to print a print correction pattern that is made of a plurality of patterns, whose dot recording ratios are different from one another, using dots of the same size, (2) to detect the dispersion state in which the dots are dispersed in each of the plurality of patterns, and determine whether or not there is a pattern, among those patterns, which has a problem such as banding, and (3) if there is a pattern that has a problem, then to appropriately determine, or adjust, the relationship (that is, profile) between the gray-scale value and the dot recording ratio for the dots of the same size such that the relationship (that is, profile) becomes, for example, higher or lower than the dot recording ratio of the above-described pattern with the problem. By performing such adjustments, problems such as banding in the printed image can be relieved.

Further, in the foregoing embodiments, four colors of ink in CMYK were used. It is possible, however, to use light colored inks (such as light cyan (LC), light magenta (LM), and dark yellow (DY)), in addition to these.

Furthermore, in the foregoing embodiments, a printer 22 provided with a head that ejects ink using piezo elements is employed as discussed above, but it also possible to employ various types of ejection drive elements other than piezo elements. For example, the present invention can also be adopted for printers provided with ejection drive elements of a type that eject ink using bubbles generated within the ink channel by passing a current through a heater arranged in the ink channel.

In the foregoing embodiments, the processes described above were executed by the printer driver program stored in the HDD 94 (or the external storage device 100). It is possible, however, to store a program having the same functions in the P-ROM 43 of the printer 22 and execute the above-described processes with this program, or to distribute the processes between the computer 90 and the printer 22.

It should be noted that the program, in which the functions of the above-described processes are described, can be recorded on a computer-readable storage medium. Examples of the computer-readable storage medium are magnetic recording devices, optical disks, magneto-optical storage media, and semiconductor memories. Magnetic recording devices include hard disk devices (HDDs), flexible disks (FDs), magnetic tapes, and so forth. Optical disks include DVDs, DVD-RAMs (Random Access Memory), CD-ROMs, CD-Rs (Recordable), CD-RWs (Rewritable), and so forth. Magneto-optical storage media include MOs for example.

If the program is to be distributed, then, for example, it is possible to sell portable storage media such as DVDs and CD-ROMs having the program recorded thereon. It is also possible to store the program in a storage device of a server computer, and transfer the program from the server computer to other computers via a network.

For example, a computer that executes the program stores the program, which may have been recorded on the portable recording medium or transferred from the server computer, in its own storage device. Then the computer reads out the program from its storage device and executes processes according thereto. It should be noted that the computer could also read out the program directly from the portable recording medium and execute processes according thereto. The computer may also execute processes according to a program that it receives, every time a program is transferred from the server computer.

1. A printing method comprising the steps of:
printing a print correction pattern on a medium, wherein said print correction pattern is made up of a plurality of patterns, wherein each of said plurality of patterns has a dot recording ratio different from one another, wherein said dot recording ratio is a ratio at which dots are recorded per unit area, wherein each of said plurality of patterns is formed from a multitude of dots, and wherein each of said dots is formed by an ink droplet being ejected onto said medium; and
adjusting a relationship between a gray-scale value of said dots and said dot recording ratio according to a result of detecting a dispersion state of said multitude of dots in each of said plurality of patterns included in said print correction pattern that has been printed.

2. A printing method according to claim 1, wherein:
in said printing step, N types of the print correction patterns, each being formed from dots of a size that differs from the other types, are printed by ejecting, onto said medium, N types of ink droplets that respectively have different ink amounts;
N is an integer of at least 2; and
the relationship between the gray-scale value and the dot recording ratio is adjusted for each of the N types of dots of different sizes formed by ejecting said N types of ink droplets.

3. A printing method according to claim 2, wherein
in said printing step, the print correction pattern that is formed from dots of the smallest size, and one or two or more of the print correction patterns that are formed from dots of the next smallest one or two or more different sizes, are printed by ejecting, onto said medium, ink droplets whose ink amount is the smallest among said N types of ink droplets, and one or two or more types of ink droplets whose ink amount is next smallest.

4. A printing method according to claim 2, wherein
if, by detecting the dispersion state of said multitude of dots, the occurrence of banding is detected in one of said plurality of patterns that are included in the print correction pattern that is formed from dots of a particular size, then
an upper limit of the dot recording ratio for the dots of said particular size is set to a value in the vicinity of the dot recording ratio of said one pattern in which said banding is occurring, and
the dot recording ratio for dots of a size that is larger than the dots of said particular size is changed.

5. A printing method according to claim 4, wherein:
said ink droplets are ejected from a plurality of nozzles; and
for only the nozzle, from among said plurality of nozzles, that caused said banding, the dot recording ratio is changed such that dots other than the dots of the smallest size, which are formed by the ink droplets that are ejected from said nozzle, are created starting from a smaller gray-scale value.

6. A printing method according to claim 4, wherein:
said ink droplets are ejected from a plurality of nozzles; and
for the nozzle, from among said plurality of nozzles, that caused said banding and at least one other nozzle in the vicinity of said nozzle, the dot recording ratio for dots other than the dots of the smallest size, which are formed by the ink droplets that are ejected from those nozzles, is made larger.

7. A printing method according to claim 1, wherein:
said ink droplets are ejected from a plurality of nozzles; and
for all of said plurality of nozzles, the dot recording ratio for dots formed by said ink droplets that are ejected from each of said nozzles is adjusted.

8. A printing method according to claim 1, wherein:
said plurality of patterns that are included in said print correction pattern are read optically; and
whether or not banding has occurred in any of said plurality of patterns is detected based on results of said reading.

9. A printing method comprising the steps of:
printing a print correction pattern on a medium, wherein said print correction pattern is made up of a plurality of patterns, wherein each of said plurality of patterns has a dot recording ratio different from one another, wherein said dot recording ratio is a ratio at which dots are recorded per unit area, wherein each of said plurality of patterns is formed from a multitude of dots, and wherein each of said dots is formed by an ink droplet being ejected onto said medium; and
adjusting a relationship between a gray-scale value of said dots and said dot recording ratio according to a result of optically reading and detecting a dispersion state of said multitude of dots in each of said plurality of patterns included in said print correction pattern that has been printed;
wherein, in said printing step, N types of the print correction patterns, each being formed from dots of a size that differs from the other types, are printed by ejecting, onto said medium, N types of ink droplets that respectively have different ink amounts;
wherein N is an integer of at least 2;
wherein the relationship between the gray-scale value and the dot recording ratio is adjusted for each of the N types of dots of different sizes formed by ejecting said N types of ink droplets;
wherein, in said printing step, the print correction pattern that is formed from dots of the smallest size, and one or two or more of the print correction patterns that are formed from dots of the next smallest one or two or more different sizes, are printed by ejecting, onto said medium, ink droplets whose ink amount is the smallest among said N types of ink droplets, and one or two or more types of ink droplets whose ink amount is next smallest;
wherein, if, by detecting the dispersion state of said multitude of dots, the occurrence of banding is detected in one of said plurality of patterns that are included in the print correction pattern that is formed from dots of a particular size, then
an upper limit of the dot recording ratio for the dots of said particular size is set to a value in the vicinity of the dot recording ratio of said one pattern in which said banding is occurring, and
the dot recording ratio for dots of a size that is larger than the dots of said particular size is changed;
wherein said ink droplets are ejected from a plurality of nozzles;
wherein, for only the nozzle, from among said plurality of nozzles, that caused said banding, the dot recording ratio is changed such that dots other than the dots of the smallest size, which are formed by the ink droplets that are ejected from said nozzle, are created starting from a smaller gray-scale value; and
wherein, for the nozzle, from among said plurality of nozzles, that caused said banding and at least one other nozzle in the vicinity of said nozzle, the dot recording ratio for dots other than the dots of the smallest size, which are formed by the ink droplets that are ejected from those nozzles, is made larger.

10. A printing apparatus comprising:
a plurality of nozzles for ejecting ink droplets onto a medium to form dots on said medium; and
a controller for controlling actions of said plurality of nozzles; said controller causing said plurality of nozzles to print a print correction pattern on said medium, wherein said print correction pattern is made up of a plurality of patterns, wherein each of said plurality of patterns has a dot recording ratio different from one another, wherein said dot recording ratio is a ratio at which dots are recorded per unit area, wherein each of said plurality of patterns is formed from a multitude of dots, and wherein each of said dots is formed by one of said plurality of nozzles ejecting an ink droplet onto said medium; and said controller adjusting a relationship between a gray-scale value of said dots and said dot recording ratio according to a result of detecting a dispersion state of said multitude of dots in each of said plurality of patterns included in said print correction pattern that has been printed.

11. A computer-readable storage medium having recorded thereon a program, wherein said program is for a printing apparatus, and said program causes said printing apparatus to execute:
a step of printing a print correction pattern on a medium, wherein said print correction pattern is made up of a plurality of patterns, wherein each of said plurality of patterns has a dot recording ratio different from one another, wherein said dot recording ratio is a ratio at which dots are recorded per unit area, wherein each of said plurality of patterns is formed from a multitude of dots, and wherein each of said dots is formed by an ink droplet being ejected onto said medium; and
a step of adjusting a relationship between a gray-scale value of said dots and said dot recording ratio according to a result of detecting a dispersion state of said multitude of dots in each of said plurality of patterns included in said print correction pattern that has been printed.

12. A print correction pattern that is printed on a medium, comprising:
a plurality of patterns, each of said plurality of patterns having a dot recording ratio different from one another;
wherein said dot recording ratio is a ratio at which dots are recorded per unit area;
wherein each of said plurality of patterns is formed from a multitude of dots;
wherein each of said dots is formed by an ink droplet being ejected onto said medium; and
wherein said print correction pattern is used for adjusting a relationship between a gray-scale value of said dots and said dot recording ratio according to a result of detecting a dispersion state of said multitude of dots in each of said plurality of patterns included in said print correction pattern that has been printed.

13. A printing method of intermittently feeding a medium by a predetermined feed amount and printing on said medium during intervals between the intermittent feeding, comprising the steps of:
printing, on said medium, a feed amount correction pattern for correcting said feed amount of said medium;
correcting said feed amount of said medium based on said feed amount correction pattern;
printing a print correction pattern on said medium, wherein said print correction pattern is made up of a plurality of patterns, wherein each of said plurality of patterns has a dot recording ratio different from one another, wherein said dot recording ratio is a ratio at which dots are recorded per unit area, wherein each of said plurality of patterns is formed from a multitude of dots, and wherein each of said dots is formed by an ink droplet being ejected onto said medium; and
adjusting a relationship between a gray-scale value of said dots and said dot recording ratio according to a result of detecting a dispersion state of said multitude of dots in each of said plurality of patterns included in said print correction pattern that has been printed.

14. A printing method according to claim 13, wherein:
in the step of printing said print correction pattern, N types of the print correction patterns, each being formed from dots of a size that differs from the other types, are printed by ejecting, onto said medium, N types of ink droplets that respectively have different ink amounts;
N is an integer of at least 2; and
the relationship between the gray-scale value and the dot recording ratio is adjusted for each of the N types of dots of different sizes formed by ejecting said N types of ink droplets.

15. A printing method according to claim 13, wherein:
said ink droplets are ejected from a plurality of nozzles;
during the intervals between said intermittent feeding, a line is formed on said medium in a direction that intersects a feed direction of said medium by repeatedly ejecting said ink droplets from at least one of said plurality of nozzles;
said feed amount correction pattern includes at least two of the lines; and
in the step of correcting said feed amount, said feed amount of said medium is corrected according to said lines that are included in said feed amount correction pattern.

16. A printing method according to claim 15, wherein
in the step of correcting said feed amount,
said lines that are included in said feed amount correction pattern are optically read, and
said feed amount of said medium is corrected according to a result of said reading.

17. A printing method according to claim 13, wherein in the step of adjusting,
said plurality of patterns that are included in said print correction pattern are optically read, and
the relationship between the gray-scale value of said dots and said dot recording ratio is adjusted according to a result of said reading.

18. A printing method of intermittently feeding a medium by a predetermined feed amount and printing on said medium during intervals between the intermittent feeding, comprising the steps of:
printing, on said medium, a feed amount correction pattern for correcting said feed amount of said medium;
correcting said feed amount of said medium based on said feed amount correction pattern;
printing a print correction pattern on said medium, wherein said print correction pattern is made up of a plurality of patterns, wherein each of said plurality of patterns has a dot recording ratio different from one another, wherein said dot recording ratio is a ratio at which dots are recorded per unit area, wherein each of said plurality of patterns is formed from a multitude of dots, and wherein each of said dots is formed by an ink droplet being ejected onto said medium;
adjusting a relationship between a gray-scale value of said dots and said dot recording ratio according to a result of detecting a dispersion state of said multitude of dots in each of said plurality of patterns included in said print correction pattern that has been printed;
printing the print correction pattern again according to said relationship between said gray-scale value of said dots and said dot recording ratio that has been adjusted in said step of adjusting; and
repeating said step of adjusting if the occurrence of banding is detected as a result of detecting whether or not banding has occurred in any of said plurality of patterns that are included in said print correction pattern that has been printed again.

19. A printing method according to claim 18, wherein
if the occurrence of banding is detected even after said step of repeating, then the step of correcting said feed amount of said medium is repeated.

20. A printing method according to claim 19, wherein
if the occurrence of banding is caused by the presence of a portion of low darkness, then said feed amount is corrected by reducing said feed amount.

21. A printing method of intermittently feeding a medium by a predetermined feed amount and printing on said medium during intervals between the intermittent feeding, comprising the steps of:
printing, on said medium, a feed amount correction pattern for correcting said feed amount of said medium;
correcting said feed amount of said medium based on said feed amount correction pattern;
printing a print correction pattern on said medium, wherein said print correction pattern is made up of a plurality of patterns, wherein each of said plurality of patterns has a dot recording ratio different from one another, wherein said dot recording ratio is a ratio at which dots are recorded per unit area, wherein each of said plurality of patterns is formed from a multitude of dots, and wherein each of said dots is formed by an ink droplet being ejected onto said medium; and
adjusting a relationship between a gray-scale value of said dots and said dot recording ratio according to a result of detecting a dispersion state of said multitude of dots in each of said plurality of patterns included in said print correction pattern that has been printed;
wherein, in the step of printing said print correction pattern, N types of the print correction patterns, each being formed from dots of a size that differs from the other types, are printed by ejecting, onto said medium, N types of ink droplets that respectively have different ink amounts;
wherein N is an integer of at least 2;
wherein the relationship between the gray-scale value and the dot recording ratio is adjusted for each of the N types of dots of different sizes formed by ejecting said N types of ink droplets;
wherein said ink droplets are ejected from a plurality of nozzles;
wherein, during the intervals between said intermittent feeding, a line is formed on said medium in a direction that intersects a feed direction of said medium by repeatedly ejecting said ink droplets from at least one of said plurality of nozzles;
wherein said feed amount correction pattern includes at least two of the lines;
wherein in the step of correcting said feed amount, said feed amount of said medium is corrected according to said lines that are included in said feed amount correction pattern;
wherein in the step of correcting said feed amount,
said lines that are included in said feed amount correction pattern are optically read, and
said feed amount of said medium is corrected according to a result of said reading; and
wherein in the step of adjusting,
said plurality of patterns that are included in said print correction pattern are optically read, and
the relationship between the gray-scale value of said dots and said dot recording ratio is adjusted according to a result of said reading.

22. A printing method of intermittently feeding a medium by a predetermined feed amount and printing on said medium during intervals between the intermittent feeding, comprising the steps of:
printing, on said medium, a feed amount correction pattern for correcting said feed amount of said medium;
correcting said feed amount of said medium based on said feed amount correction pattern;
printing a print correction pattern on said medium, wherein said print correction pattern is made up of a plurality of patterns, wherein each of said plurality of patterns has a dot recording ratio different from one another, wherein said dot recording ratio is a ratio at which dots are recorded per unit area, wherein each of said plurality of patterns is formed from a multitude of dots, and wherein each of said dots is formed by an ink droplet being ejected onto said medium;
adjusting a relationship between a gray-scale value of said dots and said dot recording ratio according to a result of detecting a dispersion state of said multitude of dots in each of said plurality of patterns included in said print correction pattern that has been printed;
printing the print correction pattern again according to said relationship between said gray-scale value of said dots and said dot recording ratio that has been adjusted in said step of adjusting; and
repeating said step of adjusting if the occurrence of banding is detected as a result of detecting whether or not banding has occurred in any of said plurality of patterns that are included in said print correction pattern that has been printed again;
wherein if the occurrence of banding is detected even after said step of repeating, then the step of correcting said feed amount of said medium is repeated; and
wherein if the occurrence of banding is caused by the presence of a portion of low darkness, then said feed amount is corrected by reducing said feed amount.

23. A printing apparatus comprising:
a carrying mechanism for intermittently feeding a medium by a predetermined feed amount;
a plurality of nozzles for ejecting ink droplets onto said medium to form dots on said medium during intervals between the intermittent feeding; and
a controller for controlling actions of said plurality of nozzles; said controller causing said plurality of nozzles to print, on said medium, a feed amount correction pattern for correcting said feed amount of said medium; said controller correcting said feed amount of said medium based on said feed amount correction pattern; said controller causing said plurality of nozzles to print a print correction pattern on said medium, wherein said print correction pattern is made up of a plurality of patterns, wherein each of said plurality of patterns has a dot recording ratio different from one another, wherein said dot recording ratio is a ratio at which dots are recorded per unit area, wherein each of said plurality of patterns is formed from a multitude of dots, and wherein each of said dots is formed by one of said plurality of nozzles ejecting an ink droplet onto said medium; and said controller adjusting a relationship between a gray-scale value of said dots and said dot recording ratio according to a result of detecting a dispersion state of said multitude of dots in each of said plurality of patterns included in said print correction pattern that has been printed.

24. A printing apparatus comprising:
a carrying mechanism for intermittently feeding a medium by a predetermined feed amount;
a plurality of nozzles for ejecting ink droplets onto said medium to form dots on said medium during intervals between the intermittent feeding; and
a controller for controlling actions of said plurality of nozzles; said controller causing said plurality of nozzles to print, on said medium, a feed amount correction pattern for correcting said feed amount of said medium; said controller correcting said feed amount of said medium based on said feed amount correction pattern; said controller causing said plurality of nozzles to print a print correction pattern on said medium, wherein said print correction pattern is made up of a plurality of patterns, wherein each of said plurality of patterns has a dot recording ratio different from one another, wherein said dot recording ratio is a ratio at which dots are recorded per unit area, wherein each of said plurality of patterns is formed from a multitude of dots, and wherein each of said dots is formed by one of said plurality of nozzles ejecting an ink droplet onto said medium; said controller adjusting a relationship between a gray-scale value of said dots and said dot recording ratio according to a result of detecting a dispersion state of said multitude of dots in each of said plurality of patterns included in said print correction pattern that has been printed; said controller causing said plurality of nozzles to print the print correction pattern again according to said relationship between said gray-scale value of said dots and said dot recording ratio that has been adjusted in said step of adjusting; and said controller repeating adjustment of the relationship between the gray-scale value of said dots and said dot recording ratio if the occurrence of banding is detected as a result of detecting whether or not banding has occurred in any of said plurality of patterns that are included in said print correction pattern that has been printed again.

25. A computer-readable storage medium having recorded thereon a program, wherein said program is for a printing apparatus that intermittently feeds a medium by a predetermined feed amount and prints on said medium during intervals between the intermittent feeding, and said program causes said printing apparatus to execute:
a step of printing, on said medium, a feed amount correction pattern for correcting said feed amount of said medium;
a step of correcting said feed amount of said medium based on said feed amount correction pattern;
a step of printing a print correction pattern on said medium, wherein said print correction pattern is made up of a plurality of patterns, wherein each of said plurality of patterns has a dot recording ratio different from one another, wherein said dot recording ratio is a ratio at which dots are recorded per unit area, wherein each of said plurality of patterns is formed from a multitude of dots, and wherein each of said dots is formed by an ink droplet being ejected onto said medium; and
a step of adjusting a relationship between a gray-scale value of said dots and said dot recording ratio according to a result of detecting a dispersion state of said multitude of dots in each of said plurality of patterns included in said print correction pattern that has been printed.

26. A computer-readable storage medium having recorded thereon a program, wherein said program is for a printing apparatus that intermittently feeds a medium by a predetermined feed amount and prints on said medium during intervals between the intermittent feeding, and said program causes said printing apparatus to execute:
a step of printing, on said medium, a feed amount correction pattern for correcting said feed amount of said medium;
a step of correcting said feed amount of said medium based on said feed amount correction pattern;
a step of printing a print correction pattern on said medium, wherein said print correction pattern is made up of a plurality of patterns, wherein each of said plurality of patterns has a dot recording ratio different from one another, wherein said dot recording ratio is a ratio at which dots are recorded per unit area, wherein each of said plurality of patterns is formed from a multitude of dots, and wherein each of said dots is formed by an ink droplet being ejected onto said medium;
a step of adjusting a relationship between a gray-scale value of said dots and said dot recording ratio according to a result of detecting a dispersion state of said multitude of dots in each of said plurality of patterns included in said print correction pattern that has been printed;
a step of printing the print correction pattern again according to said relationship between said gray-scale value of said dots and said dot recording ratio that has been adjusted in said step of adjusting; and
a step of repeating said step of adjusting if the occurrence of banding is detected as a result of detecting whether or not banding has occurred in any of said plurality of patterns that are included in said print correction pattern that has been printed again.

27. A print correction pattern that is printed on a medium, comprising:
a feed amount correction pattern for correcting the feed amount of said medium; and
a plurality of patterns, each of said plurality of patterns having a dot recording ratio different from one another;
wherein said feed amount correction pattern is used for correcting said feed amount of said medium;
wherein said dot recording ratio is a ratio at which dots are recorded per unit area;
wherein each of said plurality of patterns is formed from a multitude of dots;
wherein each of said dots is formed by an ink droplet being ejected onto said medium; and
wherein said print correction pattern is used for adjusting a relationship between a gray-scale value of said dots and said dot recording ratio according to a result of detecting a dispersion state of said multitude of dots in each of said plurality of patterns included in said print correction pattern that has been printed.
